(19) United States
(12) Patent Application Publication
(10) Pub. No.: US 2015/0032509 A1
(43) Pub. Date: Jan. 29, 2015

(54) GATHERING USER INFORMATION BASED ON USER INTERACTIONS

(71) Applicant: SR Solutions, Inc., Maspeth, NY (US)

(72) Inventors: Jose Rodrigo Fuentes, Maspeth, NY (US); Sandeep Arneja, Jersey City, NJ (US)

(21) Appl. No.: 14/445,356

(22) Filed: Jul. 29, 2014

Related U.S. Application Data
(60) Provisional application No. 61/859,329, filed on Jul. 29, 2013.

(51) Int. Cl. G06Q 30/02; G06F 3/0484

(52) U.S. Cl. CPC G06Q 30/0203; G06F 3/04842
USPC 705/7.32

(57) ABSTRACT

A computer-implemented method includes displaying an element at a web-based information resource rendered on a computer-based user interface device, enabling a user to interact with the element from the computer-based user interface device, and, in response to the user interacting with the element at the computer-based user interfaced device, displaying a data collection module at the computer-based user interface device. The data collection module is configured to solicit data from the user about the element, the user or the user's opinion about the element.

### CROSS-REFERENCE TO RELATED APPLICATION

This application claims the benefit of priority to U.S. Provisional Application No. 61/859,329, filed Jul. 29, 2013, entitled METHOD AND SYSTEM FOR GATHERING USER INFORMATION BASED ON USER INTERACTIONS. The provisional application is incorporated by reference herein in its entirety.

### TECHNICAL FIELD

The present invention relates to a method and system for gathering user information based on user interactions.

### BACKGROUND

Internet applications can be used to gather information about a product from a user.

### SUMMARY

The details of one or more implementations are set forth in the accompanying drawings and the description below.

One aspect includes a computer-implemented method that includes providing a feature for display at a web-based information resource, wherein the feature for display suggests an associated functionality, receiving an indication that a user has interacted with the provided feature at a computer-based user interface device, and, in response to the received indication, soliciting feedback from the user at the computer-based user interface device as to the user's interest in the associated functionality.

In some implementations, one or more of the following advantages are present.

For example, in a typical implementation, a web-site provider may be able to solicit feedback from actual users of the web-site as to whether a particular, contemplated (but not yet built out) feature would be desirable. With feedback that certain features are more desirable than others, the web-site provider will be able to intelligently allocate resources to building out only the most desirable features, which can be particularly important where budget is a driving factor. The feedback can be obtained in a very natural manner because the user can see exactly what the feature would be. Moreover, in some implementations, the users can provide written feedback, including indicating whether there might be ways to improve the planned feature to make it even more desirable.

In addition, in some implementations, the users can easily volunteer to participate in a beta test of the feature, for example, and thereby gain early access to the functionalities associated therewith.

Another aspect includes a computer-implemented method that includes providing an element for display at a web-based information resource, wherein a user may interact with the element, receiving an indication that a user has interacted with the element at a computer-based user interface device, and, in response to the received indication, soliciting information from the user at the computer-based user interface device as to the user's satisfaction with the web-based information resource, the user's psychographics, or the user's demographics.

For example, in a typical implementation, a web-site provider may be able to solicit customer satisfaction surveys from actual users of the web-site as to the likelihood that the user would recommend or refer the web-site to friends or colleagues. With customer satisfaction data, the web-site provider will be able to measure its customer satisfaction score across its users. Such data can be obtained in a very natural manner because the user is prompted for information at the point of interaction with the web-site.

In some implementations, a web-site provider may be able to solicit user psychographic information—such as interests, opinions, attitudes, and values—from actual users of the web-site, relating such responses to the web-site provider's data about such users. With such psychographic information, the web-site provider will be able to correlate which user psychographics drive the most revenue, for instance. Again, such user psychographics can be obtained in a very natural manner because the user is prompted for information at the point of interaction with the web-site.

Other features and advantages will be apparent from the following description, the accompanying drawings, and the claims.

### BRIEF DESCRIPTION OF THE DRAWINGS

FIG. 1a is a block diagram of a computer system.

FIG. 1b is a block diagram of a computer system.

FIG. 1c is a block diagram of a computer system.

FIG. 2a is a screenshot of a modal window on a webpage.

FIG. 2b is a screenshot of a modal window on a webpage.

FIG. 3a is a block diagram of a data management unit.

FIG. 3b is a block diagram of a data management unit.

FIG. 3c is a block diagram of a data management unit.

FIG. 3d is a block diagram of a data management unit.

FIG. 4 is a block diagram of a database structure.

FIG. 5a is a flowchart showing an exemplary process that may be performed by a computer system.

FIG. 5b is a flowchart showing an exemplary process that may be performed by a computer system.

FIG. 5c is a flowchart showing an exemplary process that may be performed by a computer system.

FIG. 6A-6M is a series of exemplary screenshot.

### DETAILED DESCRIPTION

The present disclosure provides several ways to gather information from a user about a particular element or a user at a web-based information resource, where the gathered information represents, for example, without limitation, (i) information about a software application, (ii) feedback about a given feature for that software, (iii) bug reports with respect to the software application, (iv) satisfaction score about the web-based information resource, or (v) psychographic or demographic information about the user. In general, systems and methods are described herein whereby information may be gathered from a user about (1) a particular element or feature or (2) the user at a web-based information resource, or physical product tagged with a UR1-encoded QR code or NFC code. The term “web-based information resource”, and similar terms, should be interpreted broadly to include, for example, a website; webpage; mobile application; native application; SMS text application; chat application; email application; image, video or other piece of content that has access to a network.

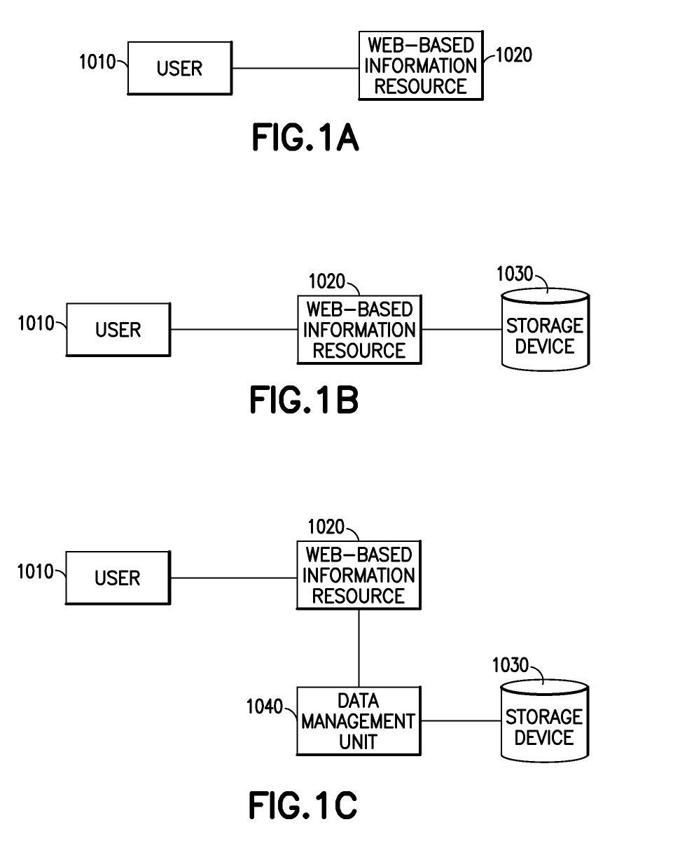

FIG. 1a-1c respectively illustrate exemplary computer systems for implementing various techniques disclosed herein. In a typical implementation, the computer system records feedback information from a user about a particular element that embodies or triggers a feature at a web-based information resource.

Referring to FIG. 1a, an exemplary computer system includes a web-based information resource 1020 such as a website accessible by a user 1010 (at a computer-based user interface, such as a laptop computer or the like) connected to the Internet. In some implementations, the web-based information resource may include a website accessible via a local intranet. There are references made throughout this application to a user accessing a resource or a taking certain other actions that normally would be or could be done by or with a computer. In general, where these types of references appear, it is intended that the user actions are actually actions taken by a computer-based user interface device (e.g., a computer) for, on behalf of, or under the direction of the user.

In the illustrated implementation, the web-based information resource 1020 is operable to display an element, such as a button; enable a user (e.g., from a computer-based user interface device) 1010 to interact with the element, such as clicking on the button; and in response to the user interacting with the element, display a data collection module, such as a JavaScript overlay or popover; wherein the data collection module includes means for gathering data from the user about the element, such as form inputs or voting buttons.

FIG. 1b illustrates an embodiment similar to, but different than, the one described in FIG. 1a. In this embodiment, a web-based information resource 1020 (e.g., a website) is coupled to a storage device 1030 such as a database. In this implementation, the website 1020 is operable to store information gathered by the data collection module at the database 1030. The database 1030 may store various information, such as a user's unique token, visitor session ID, visit count, click-on-feature count, time spent in an overlay, and the user's interactions with a data collection module, among others things.

Referring to FIG. 1 c, an exemplary computer system includes a web-based information resource 1020 coupled to a Data Management Unit (“DMU”) 1040. In this illustrated embodiment, the web-based information resource 1020 is a website accessible by a user 1010 connected to the Internet. The Data Management Unit 1040 includes a server, which may be the same server that is hosting the website (e.g., a “local server”) or an external server that is accessible via a network connection. In this exemplary embodiment, the DMU 1040 includes an external server, such as an Amazon EC2 server instance, that is operable to identify the web-based information resource 1020 and serve information specific to a data collection module at the identified web-based information resource.

In some implementations, the DMU 1040 is operable to identify the web-based information resource 1020, serve information specific to a data collection module at the identified web-based information resource, and record information about a user 1010 interaction with the data collection module at the identified web-based information resource 1020.

In another embodiment, the DMU 1040 is operable to identify the web-based information resource 1020; identify one or more elements at the web-based information resource 1020; and serve information specific to one or more data collection modules, wherein a data collection module is associated to a particular element. In another similar embodiment, the DMU 1040 may record information about a user 1010 interaction with a specific data collection module at the identified web-based information resource.

A computer system for implementing various techniques disclosed herein may include various permutations and combinations of the exemplary embodiments disclosed above. For example, the following illustrates one of many possible implementations.

A user 1010 navigates a web browser to a website 1020 identified by a URL (e.g., http://www.FeatureKicker.com). The website 1020 includes a JavaScript tag, such as: <script wbir-userid=“1” src=“//cdn.sampledomain.com/dcm.js”></script> where such HTML may incorporate JavaScript functions sourced from a data management unit 1040 that communicates with a server. The website 1020 may execute one or more JavaScript functions that communicate the website's identity (e.g., by domain name or other parameters, such as “wbir-userid”) and zero or more user interactions (e.g., which HTML elements at the website were clicked if any).

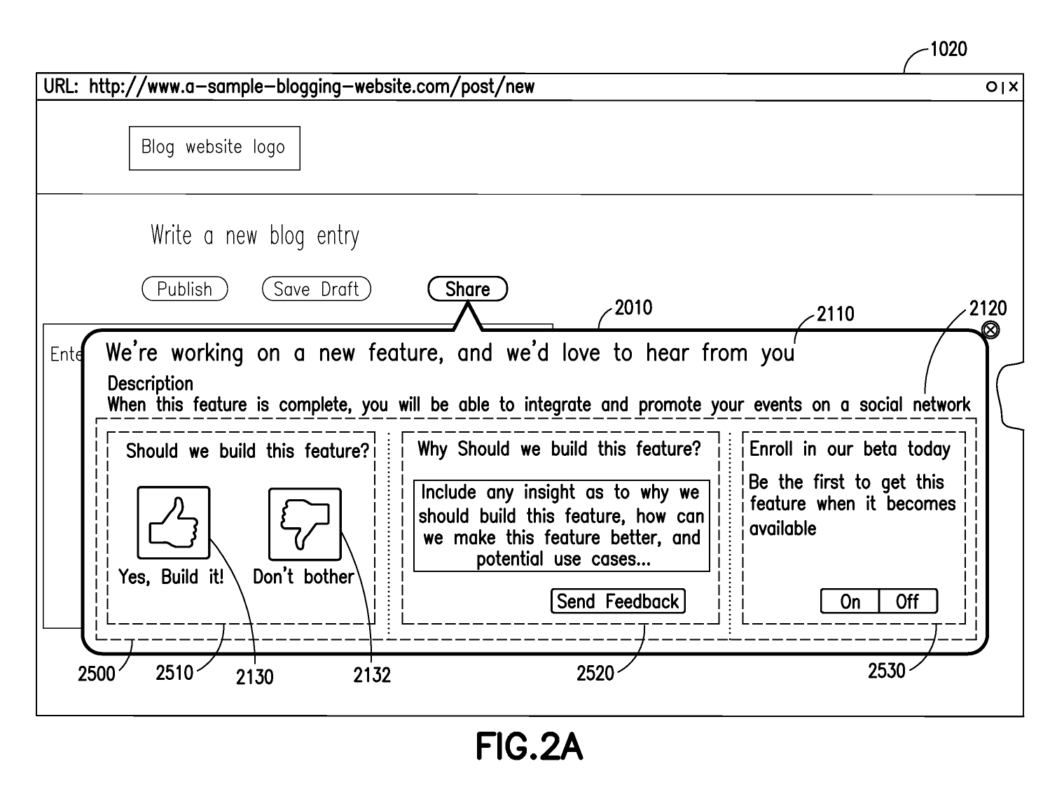

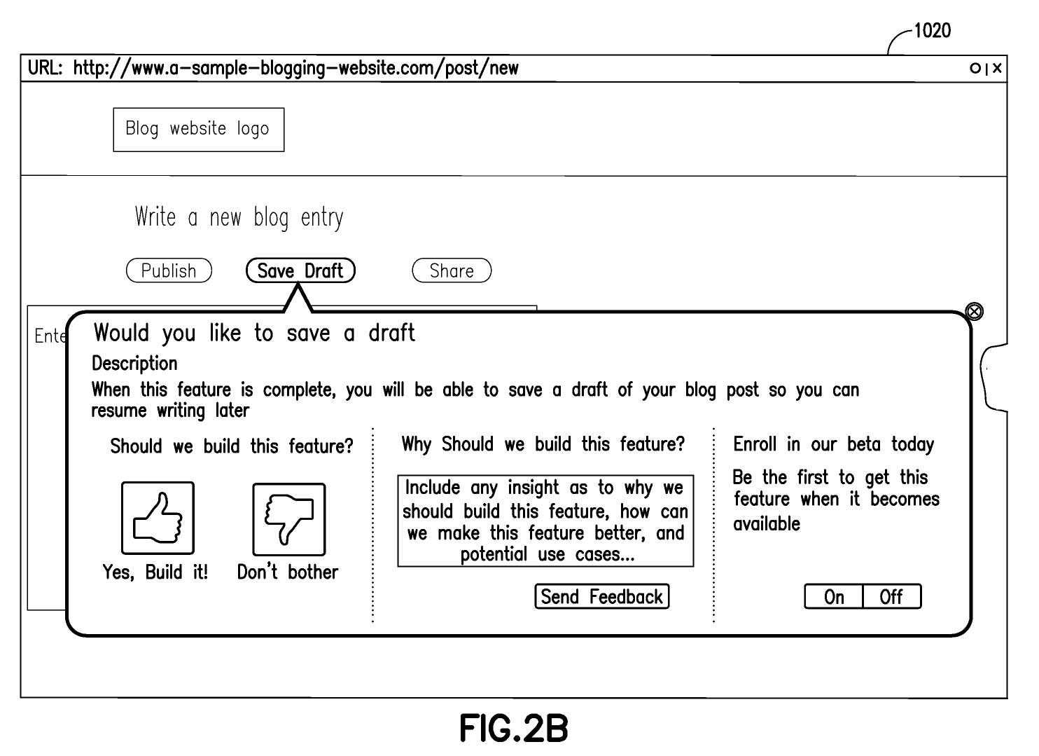

In this embodiment, the website includes certain elements, such as a two buttons, that are tagged with selectors “id=123” and “id=456”, respectively. A JavaScript function at the website 1020 is configured so that a user 1010 clicking on an element tagged with selector “id=123” communicates certain information to the DMU 1040, and, in response, the DMU 1040 responds with data to display a specific data collection module (illustrated in FIG. 2a); whereas if the user 1010 clicks on the element tagged with selector “id=456”, the DMU 1040 responds with data to display a different data collection module (illustrated in FIG. 2b).

Continuing this example, the user 1010 may click on one, both, or neither of the tagged elements, and such information is communicated to the DMU 1040, where the information may be stored in a database. Additionally, if a user 1010 interacts with a data collection module (e.g., by clicking, highlighting, inputting data, hovering-over one or more elements or data collection widgets 2500 of the data collection module 2010 illustrated in FIG. 2a), such interactions are communicated to the external server 1040, where that information may be stored in a database.

As used herein, the phrase “data collection module” and the like should be interpreted broadly to include virtually any kind of interface that may appear on a computer-based user interface device accessing a web-based information resource to enable a collection of data.

### Data Management Unit

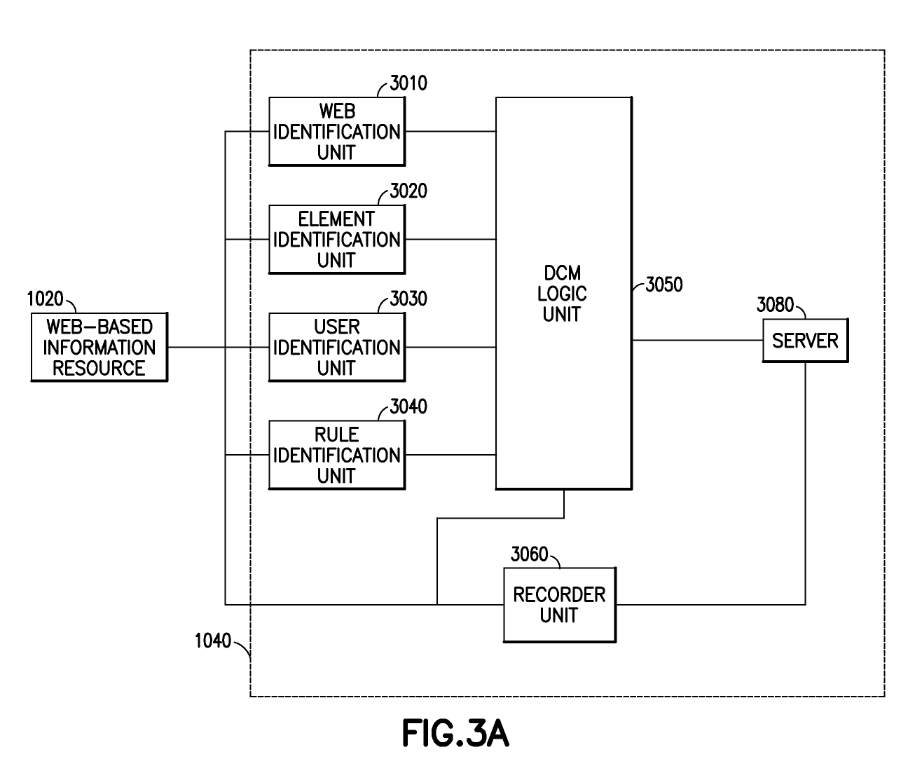

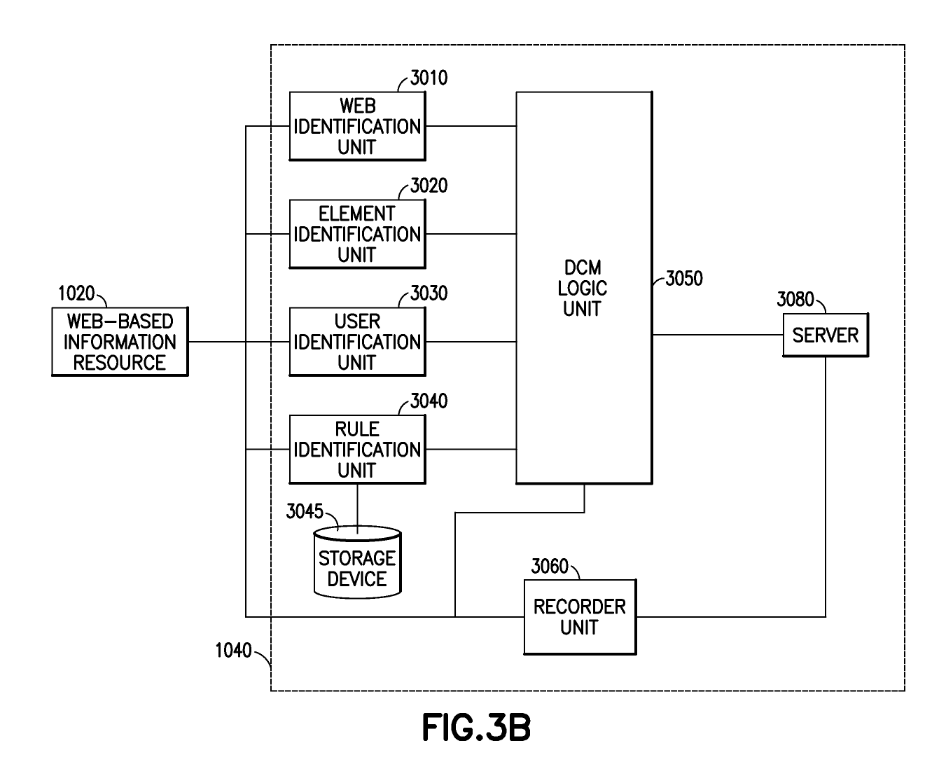

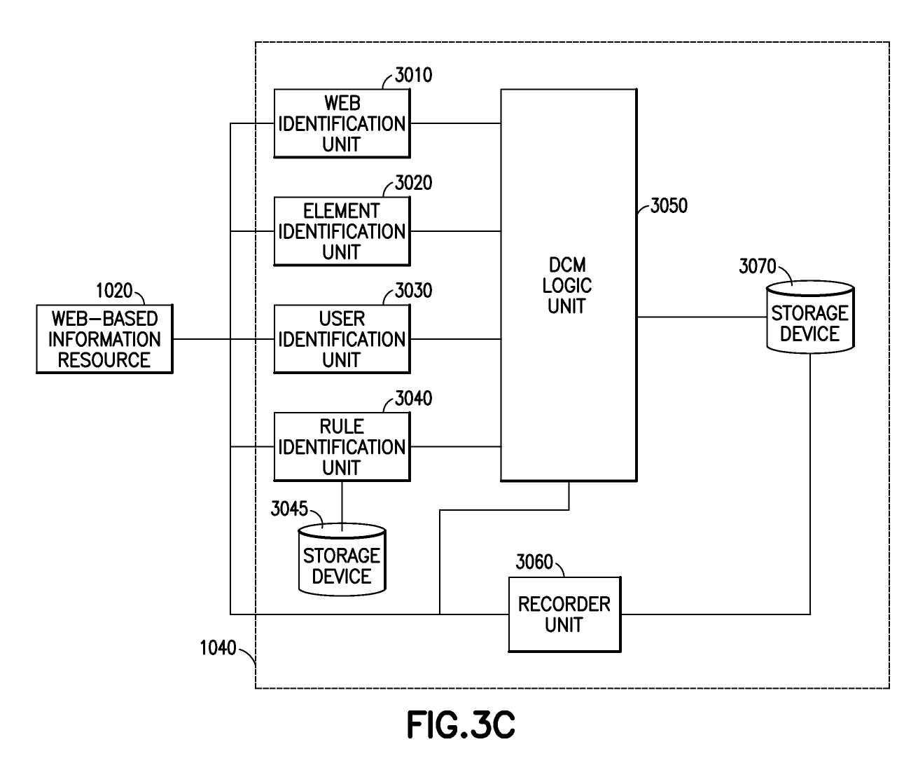

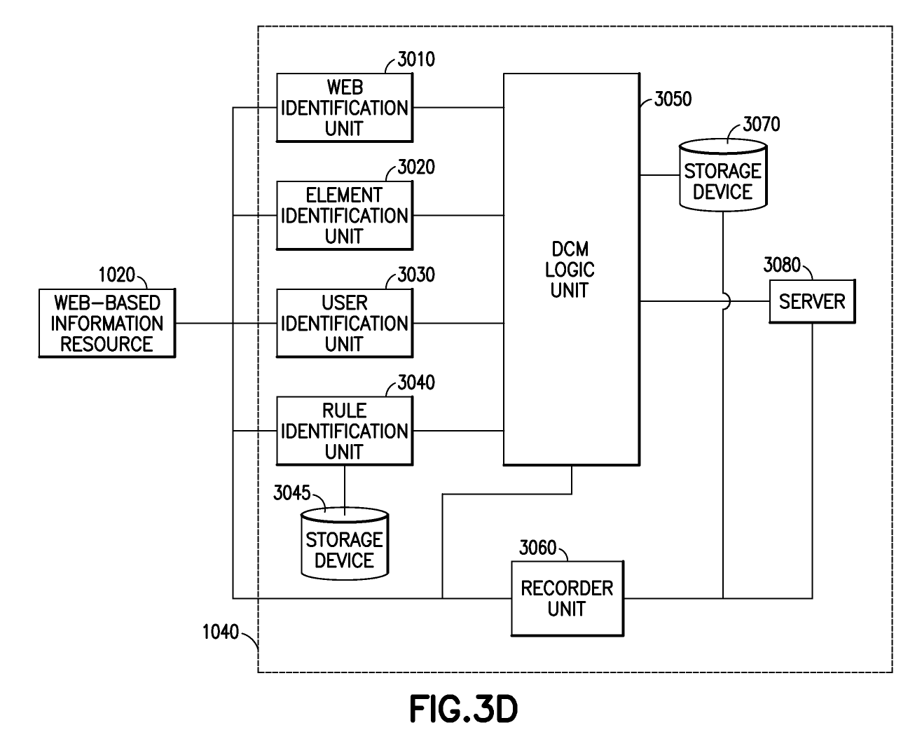

FIG. 3 is a block diagram exemplifying one implementation of the Data Management Unit 1040. In a typical embodiment, the DMU includes code executable on a user's web browser (e.g., JavaScript) that is operable to identify a user, identify a web-based information resource, identify zero or more particular elements at the web-based information resource, identify zero or more rules that control whether to display the data collection module, request information specific to a particular data collection module, determine whether to display a data collection module at the web-based information resource, display the information specific to a particular data collection module at the web-based information resource, and record a user's interactions with the data collection module at the web-based information resource.

Referring to FIG. 3a, an exemplary DMU 1040 may include a web identification unit 3010, an element identification unit 3020, a user identification unit 3030, a rule identification unit 3040, a DCM logic unit 3050, a recorder unit 3060, and a server 3080.

### Web Identification Unit

The web identification unit 3010 may receive information from a web-based information resource 1020 and communicate with a DCM logic unit 3050. In certain embodiments, the web identification unit 3010 may receive identifying information from a web-based information resource, such as a requesting website's domain name. In some implementations, the web identification unit 3010 may obtain an identifying parameter from a web-based information resource, such as the HTML of a website:

<script wbir-userid=“2” src=“//cdn.sampledomain.com/dcm.js”></script> where the “wbir-userid=2” parameter identifies a particular web-based information resource.

### Element Identification Unit

The element identification unit 3020 may obtain information from a web-based information resource 1020 and communicate with a DCM logic unit 3050. In some embodiments, the element identification unit 3020 may obtain information identifying an element at a web-based information resource. For example, in one embodiment, an element at a web-based information resource is tagged with an HTML selector, like this:

<div class=“button”>

<a id=“123” href=“javascript:void(0);”>Click me!</a>

</div>

where “id=123” is the HTML selector for an element within a div with class “button”. In this embodiment, a web-based information resource may use an event handler to trigger a JavaScript function whenever an element identified by a particular HTML selector has been clicked, wherein the JavaScript function obtains the HTML selector as the identifying information for the element to the element identification unit 3020.

### User Identification Unit

The user identification unit 3030 may obtain information from a web-based information resource 1020 and communicate with a DCM logic unit 3050. In some embodiments, the user identification unit 3030 may obtain information identifying a user at a web-based information resource. For instance, a user identification unit 3030 may identify a user based on the user's session ID or web cookie information (e.g., data sent from a website and stored in a user's web browser). In other embodiments, a user identification unit 3030 may identify a logged in user according to that user's unique database record (e.g., the “user_id” field in a User table) or the user's email address. The user identification unit 3030 may obtain the user identifying information by various means, including a request, JavaScript function, or other methods for communicating information across a network. In some implementations, a user identification unit 3030 may create a new user record in a storage device if no user is identified.

### Rule Identification Unit

A rule identification unit 3040 may communicate information to a DCM logic unit 3050, wherein the information includes zero or more rules that select whether a data collection module (and, optionally, its corresponding element) should be displayed at the web-based information resource.

Referring now to FIG. 3b, in some embodiments, a rule identification unit 3040 may receive input about which rules to communicate to the DCM logic unit 3050. For example, in one embodiment, a rule identification unit 3040 may request information —-such as which rules to communicate to the DCM logic unit 3050 —from a storage device 3045 such as a database. In some implementations, the rule identification unit 3040 may be pre-configured to include zero or more rules. In certain embodiments, the rule identification unit 3040 may obtain information from a web-based information resource (e.g., from localStorage or web cookies) about a user, about the web-based information resource, or about an element, in order to determine which rules to communicate to the DCM logic unit 3050.

By way of example, a rule may condition displaying a data collection module based on the geographic location of a user at the web-based information resource. For instance, it may be desirable to display a data collection module for users having an IP address or GPS-location in California but not New York.

Another exemplary rule includes selectively displaying a data collection module based on a user's browser session duration or session count. For instance, it may be desirable to display a data collection module only to users who have a session duration (e.g., the elapsed period of time a user has been at a web-based information resource) of more than one hour. Likewise, it may be desirable to display a data collection module only to users who have a session count (e.g., the number of times a user has loaded a web-based information resource beyond a session duration) greater than five. Similarly, another rule may include selectively displaying a data collection module based on how many times a user has visited the web-based information resource.

Still another rule may be to selectively display a data collection module based on how much time has elapsed since the last time the web-based information resource displayed a data collection module. For example, it may be desirable to limit the number of data collection modules a website displays to its users to “once a week” or “once a month” to minimize oversampling and the overall impact on a user's experience at the website.

Other rules may selectively display a data collection module based on one or more URL parameters. It may be desirable, for instance, to limit displaying a data collection module if the URL at a web-based information resource includes parameters indicating that a user was referred by a particular source. Take these URLs:

URL A:
http://sampledomain.com/?utm_source=google&utm_medium=cpc&utm_campai
gn=adgroup1
URL B:
http://sampledomain.com/?utm_source=newsletter&utm_medium=email&utm_ca
mpaign=freetips

Each URL includes various parameters, such as utm_source=google, utm_medium=cpc, utm_source=newsletter, utm_medium=email, and so on. In one embodiment, a rule may be configured to display a data collection module only if a URL excludes a certain parameter, such as “utm_medium=cpc”. Such a rule may be useful so as not to display a data collection module to a user being referred to a website from a “cost per click” advertising campaign. In some implementations, a rule may be configured to display a data collection module only if a URL includes a certain parameter, such as “utm_campaign=freetips”. Such a rule may be useful to display a data collection module only to users being referred to a website from an email newsletter campaign whose hyperlinks have been tagged with the “freetips” URL parameter.

Another rule may selectively display a data collection module based on whether a user has a proclivity to provide information via a data collection module. For instance, a DMU 1040 may record the number of times a user provides information via a data collection module, and, in some embodiments, calculate the probability that this user will provide information via a subsequent data collection module. In some cases, it may be desirable to display data collection modules to users who have a high probability of submitting information via a data collection module. In other instances, it may be beneficial to limit displaying data collection modules to users who have a low probability to submit information via a data collection module.

### Data Collection Module (“DCM”) Logic Unit

A DCM logic unit 3050 may communicate with a web identification unit 3010, an element identification unit 3020, a user identification unit 3030, a rule identification unit 3040, a web-based information resource 1020, a recorder unit 3060, and a server 3080.

Referring to FIG. 3a, in some implementations, the DCM logic unit 3050 may make a request for information about a specific data collection module to a server 3080. For example, based on information received from a web identification unit 3010, an element identification unit 3020, a user identification unit 3030, a rule identification unit 3040, the DCM logic unit 3050 may make a request for information about a specific data collection module to a server 3080, requesting information such what components the DCM may include (e.g., CSS styling; content, such as title, description, images, video; data collection widgets; ordering of the data collection widgets; and so on), and the DCM's behavior (e.g., when and how the web-based information resource should display the DCM based on criteria, such as rules from the rule identification unit 3040).

Consider the following exemplary scenario, where units 3010-3040 communicate the following information to the DCM logic unit 3050:

| | |
|---|---|
| web-id => | 2 |
| element-id => | 3 |
| user-id => | 93 |
| rule-id => | 2 |

In this scenario, a DCM logic unit 3050 may make a request to a server 3080 for one or more components of the data collection module. The server 3080 may respond with the following information:

| CSS styling | Standard (not customized) |
|---|---|
| Title | “We're working on a new feature, and |
| | we'd love to hear from you.” 2110 |
| Description | “When this feature is complete, you will be |
| | able to integrate and promote your blog |
| | posts on a social network.” 2120 |
| Images | Thumbs Up 2130, Thumbs Down 2132 |
| Widgets 2500 | Thumb Voting 2510, |
| | Freeform Text 2520, and |
| | Beta Enrollment 2530 |
| Widget Order | 1. Voting |
| | 2. Freeform Text |
| | 3. Beta Enrollment |
| Rule(s) | Display after 5 sessions |
| User Response Rate | 0.96 |

FIG. 2a shows an example of what information may be communicated to this particular data collection module.

Referring again to FIG. 3a, in one implementation, the DCM logic unit 3050 may communicate the queried information to a web-based information resource 1020, such that one or more JavaScript functions build a data collection module based on the queried information (as shown in FIG. 2a). In addition to building a data collection module, one or more JavaScript functions at the web-based information resource may evaluate rules among the queried information to selectively display the data collection module.

In another embodiment, the DCM logic unit 3050 may assemble a data collection module based on the queried information and communicate the assembled data collection module to a web-based information resource 1020 (e.g., via an HTML iframe or other transmission methods). In addition to building a data collection module, the DCM logic unit 3050 may communicate one or more rules to selectively display the data collection module at the web-based information resource.

In some embodiments, such as the one illustrated in FIG. 3c, the DCM logic unit 3050 may query a storage device 3070 to determine information about a data collection module. In some implementations, such as the one illustrated in FIG. 3d, the DCM logic unit 3050 may query a storage device 3070 and a server 3080 to determine information about a data collection module.

### Recorder Unit

A recorder unit 3060 is operable to obtain information from a web-based information resource 1020, including, without limitation, information such as one or more users' interactions with the web-based information resource and one or more users' interactions with one or more data collection modules at the web-based information resource. A recorder unit 3060 may also communicate with a storage device 3070, a server 3080, or a combination of the two.

In some embodiments, a recorder unit 3060 may obtain information about a user at a web-based information resource, including, without limitation, some or all of the following: how often the user visited a web-based information resource, the user's browser, the user's IP address, the user's pointer movement and clicks at the web-based information resource, whether the user interacted with an element that triggered a data collection module, which data collection module was displayed to a user, the duration of time that the user interacted with a data collection module, whether the user highlighted any content at a data collection module, the user's information submitted to each data widget at the data collection module, and so on. In certain implementations, a recorder unit 3060 may de-duplicate some or all of the information received.

In one embodiment, a recorder unit 3060 may communicate information to a server 3080, which may store such information in a storage device 3070. In such an embodiment, the recorder unit 3060 may store the information across multiple tables associated by keys, such that reports for a given web-based information resource may be generated and displayed. In some implementations, a recorder unit 3060 may communicate information to a storage device 3070, such as a NoSQL database.

### Storage Device

In some embodiments of FIG. 3, the DCM logic unit 3050 may be coupled to a server 3080, which may be coupled to a storage device 3070, such as a database. In some implementations, the DCM logic unit 3050 may include a storage device, such as a web browser's local storage. In one embodiment, the DCM logic unit 3050 is coupled to a storage device 3070, such as a NoSQL database. In any case, the storage device is not limited to a database, and may also include, without limitation, random access memory (RAM), magnetic tapes, USB drives, web browser cookies, and web browser localStorage.

A storage device 3070 may store various information, such as a user's unique token, session ID, visit count, click-on-feature count, time spent in an overlay, and a user's interactions with a data collection module and data collection widgets, among others things.

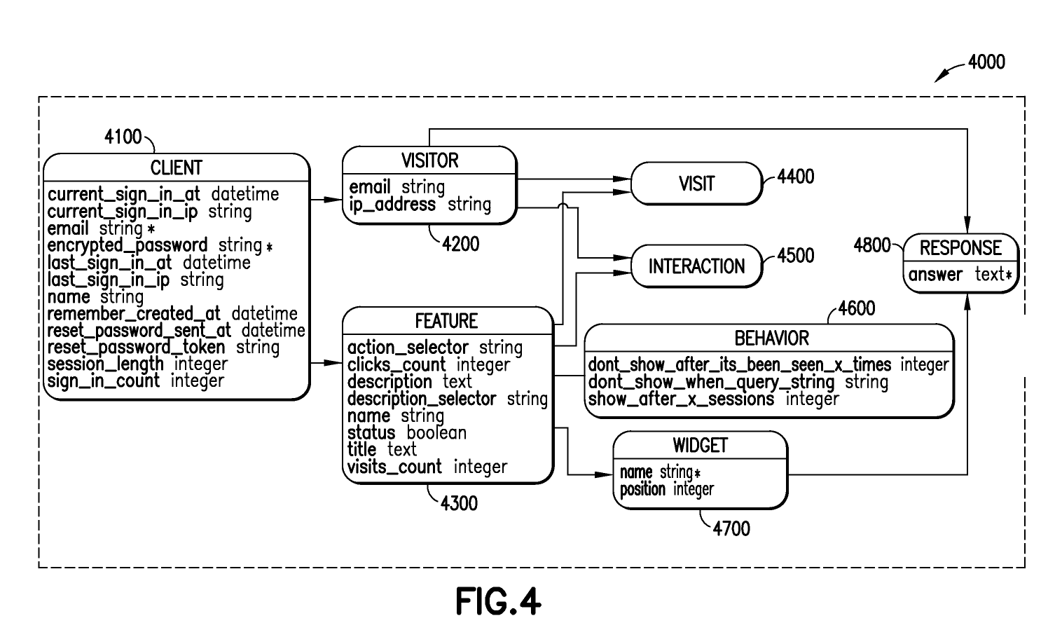

By way of example, FIG. 4 illustrates a data structure 4000 for storing information in a database. The data structure 4000 may include one or more tables, such as a Client table 4100, Visitor table 4200, Feature table 4300, Visit table 4400, Interaction table 4500, Behavior table 4600, Widget table 4700, and a Response table 4800. In this embodiment, every table has the following implied columns: id, created_at, and updated_at.

In the illustrated embodiment of FIG. 4, the Client table 4100 stores data regarding a client who is interested in gathering user 1010 feedback information about an element at a web-based information resource, wherein the Client table 4100 table may include fields like email, name, session_length, and sign_in_count, among others.

The Visitor table 4200 stores information about one or more users that visit a web-based information resource, such as a user's IP address, email address, revenue-to-date, user type, first name, last name, and so forth. This table includes implied columns that identify the client (e.g., client_id) for a given visitor. The Feature table 4300 includes information about a data collection module, such as what HTML selector(s) may trigger displaying the data collection module, the number of times the DCM has been triggered (e.g., “clicks_count”), content for the DCM (e.g., title and description), and the number of visits to a web-based information resource containing an element tagged with an HTML selector. This table includes implied columns that identify the client (e.g., client_id) for a given feature.

The Visit table 4400 stores user interaction information, such as a timestamp of when a user visited a web-based information resource. The Interaction table 4500 likewise stores user interaction information, such as a timestamp of when a user clicked on a data collection module. Both of these tables include implied columns that identify the feature (e.g., feature_id) and visitor (e.g., visitor_id) involved in that event.

The Behavior table 4600 stores information about a data collection module, such as rules that determine whether a data collection module should be displayed at the web-based information resource. In the embodiment of FIG. 4, the Behavior table 4600 includes fields indicating whether a given data collection module should be displayed if it has been displayed a certain number of times, if a web-based information resource has a URL parameter with a particular query string, and if a user has more than a certain number of sessions at the web-based information resource. This table includes implied columns that identify the feature (e.g., feature_id) for a given behavior.

The Widget table 4700 stores information about a data collection widget that may be displayed as part of a data collection module. For example, the Widget table 4700 may store data like the name of a widget, and its order position with respect to other data collection widgets. Generally speaking, a data collection widget is a means to convey information and record user interactions as part of a data collection module. This Widget table 4700 includes implied columns that identify the feature (e.g., feature_id) for a given widget.

The following examples of data collection widgets relate to a data collection module that may gather feedback about an undeveloped web application feature. For instance, one data collection widget may be a voting form that asks a user to vote up or vote down whether to build an undeveloped software feature. Another data collection widget may be an email address collection form, which allows a user to submit their email address so they can be notified about new developments relevant to the undeveloped feature. In other cases, a data collection widget may be a “beta enrollment form,” which allows a user to opt-in to be an early user of an undeveloped feature before it is generally released. Still another data collection widget may be a form that allows a user to pre-pay an amount of money in order to accelerate development of this feature.

The following examples of data collection widgets relate to a data collection module that may gather information about a user's psychographics. For instance, one data collection widget may include a form that asks a user, “On a scale of 0-10, how likely is it that you would recommend this website to a friend or colleague?” Then, if the user's response ranged from 0-6, a conditional data collection widget may be a text input form, asking “Sorry to hear that. If we could improve one thing about this website, what would that be?” In another example, a data collection widget may be a multiple choice form that asks a user “What do you care about most when booking your travel plans? [A] Convenience [B] Luxury [C] Family Environment [D] Destination.” In some implementations, this travel-related question may be presented to a user accessing a website that has nothing to do with travel, directly.

The Response table 4800 stores information about an interaction or response that a user provided while interacting with a data collection widget. In some implementations, the Response table 4800 may store a user's answer in text form or binary (which may accommodate audio and video information). This table includes implied columns that identify the widget (e.g., widget_id) and visitor (e.g., visitor_id) for a given response.

### Process

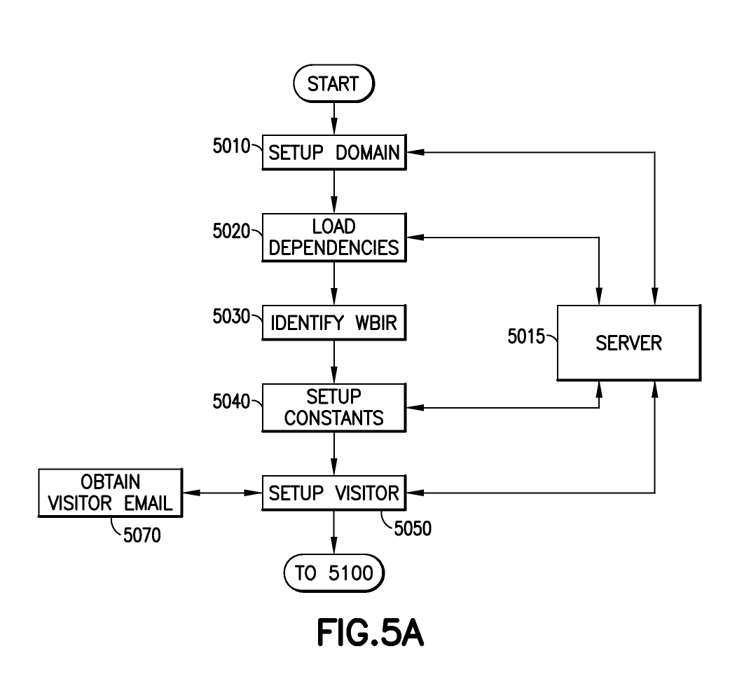

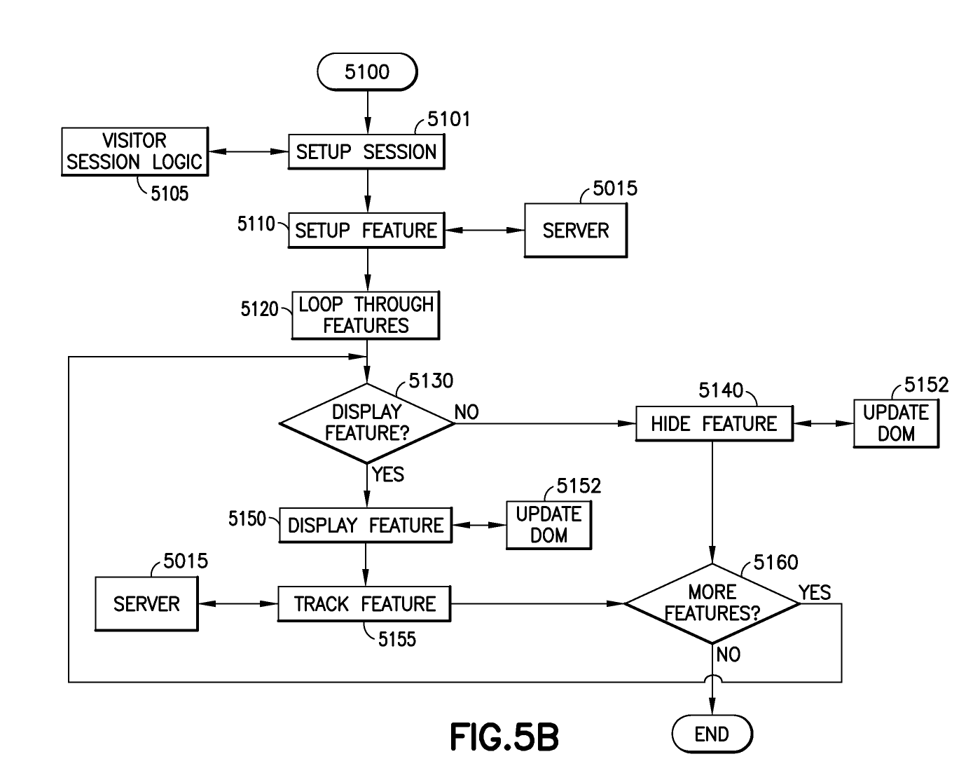

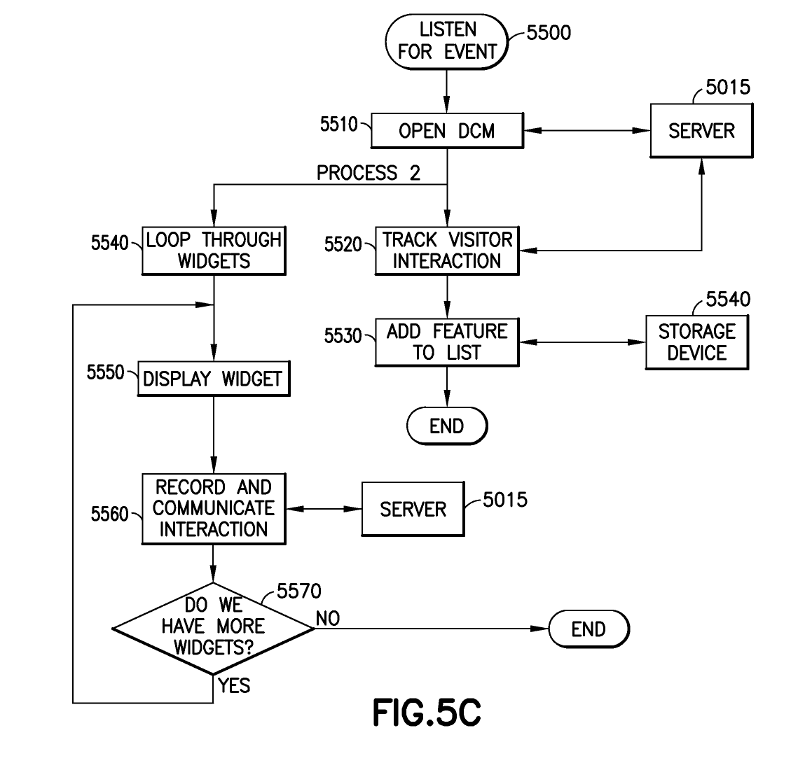

A computer system for implementing various techniques disclosed herein is provided in FIG. 1a-1c. FIG. 5a-5c depict exemplary processes that may be performed by a web-based information resource, a server, or a combination of the two.

The following exemplary process can be performed, for example, by a combination of a web-based information resource and a server (which may be local or external). To provide explanatory context, in some embodiments, this combination is representative of an external server provided by a Software-as-a-Service (SaaS) business and a web-based information resource, such as a website operated by a client of the SaaS business.

This exemplary process includes a step 5010 loading browser-executable code (e.g., JavaScript) from a server 5015 by web-based information resource (such as a website viewed on a user's web browser). Step 5010 may also identify the domain name of the server 5015 and configure the web browser to make further requests to that server 5015. In other embodiments, the browser-executable code is local to the web-based information resource, rather than loaded from a server 5015.

The exemplary process may include step 5020 to load code dependencies, such as JQuery, and the like. Step 5030 may be included to identify a web-based information resource (e.g., a client of the SaaS provider). For example, a JavaScript file loaded in step 5010 may include an ID parameter, such that step 5030 can determine a client referenced by that ID.

The exemplary process may also include step 5040 to identify constants associated to the client recognized in step 5030. For instance, the web browser may make a request to the server 5015 to identify constants, such as “Visitor Session Length” that may be used in the steps after this one. Constants may include settings for a particular client, such as session length, time zone, and the like. In some embodiments, the web browser may make a cross-domain request or a same-domain request to identify constants.

The exemplary process may include step 5050, which identifies the user visiting the web-based information resource (hereafter a “visitor”). For example, when a visitor navigates to the web-based information resource, step 5050 may check the visitor web browser to determine whether the visitor has a pre-existing identification token (e.g., checking cookies or localStorage for session ID, email address, or other unique token). Such information is communicable to step 5070.

In step 5070, if a visitor does not have a pre-existing identification token, step 5070 may obtain an identification token from the web-based information resource or create a token (e.g., a session ID or email address) and stores it in the visitor web browser (e.g., as a cookie or in localStorage). If the visitor has a pre-existing identification token, the information is communicated to the server 5015, which may store such information and execute logic to determine if the server has previously identified that visitor. The following pseudo-code illustrates step 5070 in more detail:

If ( fk.variables.visitorid && fk.variables.visitorEmail ) {

• Call server to find visitor by email and update visitor_id in Visitor
table if it is different.
• If visitor not found by email, find by visitor_id and add email to
record identified by visitor_id.

} else if ( !fk.variables.visitorid && fk.variables.visitorEmail ){

• Call server to find or create visitor in Visitor table

}else if( fk.variables.visitorid && !fk.variables.visitorEmail ){

• Call server and confirm that visitor_id exists or create a new one in
case it does not.

} else if ( !fk.variables.visitorid && !fk.variables.visitorEmail ){

• Call server to create visitor and setup its visitor_id.

} else {

• Logical error; do not setup visitor ID and email.

}

In some embodiments, the result of step 5070 is communicated to step 5050, which records the information at the visitor's web browser. In this way, the visitor's interactions may be associated with the web-based information resource.

In some embodiments of step 5050, the web-based information resource identifies a visitor's identification token in HTML, which may be parsed and communicated to a server 5015. In some implementations, the web-based information resource identifies a visitor's identification token by executing JavaScript that communicates the visitor's identification token to the server 5015. Still other embodiments of step 5050 include a web-based information resource that executes a code snippet to make a request to another server (e.g., a client's user database) to retrieve a visitor's identification token (e.g., a user's email address, user_id, or the like) and communicate such token to the server 5015.

In some embodiments, the server 5015 identifies the visitor based on the information provided by step 5050. The server 5015 may query a database to find a visitor and execute code to determine which identification criteria takes precedence over others. For example, the server 5015 queries a database and determines that a particular visitor should be identified based on its email address, despite having access to various identification data, like email address, IP address, and visitor_id.

Referring now to FIG. 5b, step 5101 includes creating and counting a session for a visitor. Generally, a session is a semi-permanent interactive information interchange between devices. This embodiment refers to an HTTP session, which allows a web-based information resource to associate information with individual visitors. Step 5105 verifies whether a visitor has an existing session (e.g., the session length for the web-based information resource has not elapsed) in localStorage or browser cookies. If so, then step 5101 proceeds to step 5110; if not, then step 5101 calls step 5105 to create a new session and increment a session counter for that visitor. The session ID and session count for a visitor may be stored locally in a web browser, on the server 5015, or other storage device. The term “visitor” is interpreted broadly to include a person, a machine, a web browser, or an account at a web-based information resource. Step 5110 loads information about one or more data collection modules (“DCM”) for a given web-based information resource. For example, step 5110 makes a request to the server 5015, which responds with an array of information about one or more data collection modules, where such information may include data found in a Feature table 4300 (e.g., action_selector, clicks_count, description, description_selector, name, status, title, visits_count) and each data collection module's corresponding behaviors in the Behavior table 4600. In some embodiments, such as this one, a data collection module is interchangeably referred to as a “feature” of a website, which represents an undeveloped aspect of the client's software product. However, in other embodiments, a data collection module is interchangeably referred to as a “conversation” or “survey” in a website, which represents one or more questions posed to a user on a website. In another embodiment, a data collection module is interchangeably referred to as an “engagement” on a website, which represents an attempt to solicit information from a user or encourage them to take a certain behavior, such as clicking on a hyperlink.

Step 5120 iteratively loops through information about one or more data collection modules identified in step 5110. For each feature (i.e., data collection module), step 5130 determines whether a web-based information resource should display the feature to the visitor.

In a typical implementation, after step 5120, the features are set up and the system starts listening for an event to occur (an event typically can be any kind of trigger based on a user action that might start a conversation).

Step 5130 makes this determination based on zero or more rules. By way of example, and without limiting the scope of the present invention, a rule may condition displaying a feature based on whether the web-based information resource URL contained a particular parameter, whether the feature had been displayed a certain number of times, whether the visitor had a certain session count, whether the visitor had a particular geographic location. Step 5130 may further condition displaying features based on a visitor's previous responses to other data collection modules, a visitor's household income, the visitor's interaction with the web-based information resource, and a visitor's offline interactions with a client, such as the number of times the visitor physically visited a store, purchased items, or returned items. It is further understood that such rules may be hardcoded in a computer system, requested from a server, or the like. Step 5130 is one embodiment of the process performed by a rule identification unit 3040 in FIG. 3a.

If step 5130 determines that a feature should not be displayed, then step 5140 hides an element associated to the feature at the web-based information resource. For instance, an element associated to a feature may be a hyperlink, button, touch gesture, or image that allows a visitor to interact with a feature. Hiding that element, therefore, may prevent a visitor from interacting with said feature. In this embodiment, hiding the feature refers to calling JavaScript to update the web browser Document Object Model (“DOM”) of the visitor in step 5152 to hide the element associated to the feature using the JQuery .hide( ) function, where said element is identified by an HTML selector.

It is understood that the term “hiding” generally refers to making an element invisible, such as by reducing opacity, applying particular CSS styles, making AJAX requests, re-rendering pages and/or processing custom browser code, such as JavaScript. For example, hiding a feature may be implemented in various ways, such as: (1) using JavaScript to add an HTML class to the element (e.g., “fk-hide”) to reference CSS that does not display the element; (2) using JavaScript to hide an HTML class with a .hide( ) function; and (3) a combination of (1) and (2) to provide redundant, fallback functionality. In other embodiments, step 5140 may be skipped (or do nothing) if the default state is to hide a feature until it is appropriate to display a feature (e.g., using JavaScript injection to display a feature into a web-based information resource).

Step 5160 determines whether there are more features to process in loop 5120. If not, then the process ends. If there are more features to loop through in 5120, then the process proceeds to step 5130.

If Step 5130 determines that a feature should be displayed, then step 5150 displays an element associated to the feature at the web-based information resource. Like step 5140, this embodiment of step 5150 includes displaying a feature by calling JavaScript to update the web browser Document Object Model (“DOM”) of the visitor 5152 to show the element associated to the feature using the JQuery .show( ) function, where said element is identified by an HTML selector.

Showing a feature may be implemented in various ways, such as: (1) using JavaScript to remove an HTML class from an element (e.g., “fk-hide”) that references CSS to not display such element; (2) using JavaScript to show an HTML class with a .show( ) function; and (3) a combination of (1) and (2) to provide redundant, fallback functionality. In other embodiments, step 5150 may use JavaScript injection or a JavaScript proxy, to selectively inject an element associated to a feature into a web-based information resource. Some implementations of step 5150 may display a feature by executing custom browser code (e.g., JavaScript) or building a feature by applying custom CSS and classes.

Step 5155 may track whether an element associated to a feature is viewable by a visitor. In this implementation, step 5155 searches the DOM for an element associated to a feature as identified by an HTML selector. If found, step 5155 makes a request to the server 5015, communicating that a given feature (identified by feature_id in a Feature table 4300) with a given visitor_id (identified by visitor_id in a Visitor table 4200) has been visited. In response, the server 5015 may create a new database record in the Visit table 4400. Step 5155 may also increment a cached counter in the Features table 4300 (e.g., the visits_count field).

In some implementations, step 5155 may track whether an element associated to a feature is visible within a visitor's browser window. For example, this implementation may not track a visit if an element associated to a feature was at browser pixel location (x:0; y:1000) and the visitor's browser window was sized (x1,x2: 0, 960; y1,y2: 0, 700). In some embodiments, step 5155 may track whether an element associated to a feature has been visited using custom logic that determines what constitutes a “tracked visit”. For example, custom logic may be provided such that a visitor's pageview of a feature may be counted only once per session. Other custom logic may provide that a tracked visit shall be counted based on visitor activity, such as login, purchase, or the like.

User Interaction with a Data Collection Module

Step 5500 includes one or more event handlers that identify whether a particular user interaction occurred. In the exemplary process illustrated by FIG. 5c, step 5500 includes an HTML DOM event onclick that triggers an event when a user clicks on an element identified by a HTML selector. For example, if a visitor clicks on a button with HTML selector “#123” that is associated to a specific feature, then an event handler triggers step 5510. In some embodiments, such event handlers are hardcoded, loaded in step 5010, or loaded in step 5130. It is understood that other events are possible, such as double-clicking, hovering, mouse-out, mouse-down, and various input gestures on certain mobile devices (e.g., pinching, swiping, shaking device).

Step 5510 makes a request to a server 5015, requesting what information can or should be displayed to a given visitor for a given feature. The server 5015 may respond with information about a specific data collection module associated to the element and its HTML selector. In the illustrated embodiment of FIG. 5c, information about the data collection module includes data found in a Feature table 4300 (e.g., action_selector, clicks_count, description, description_selector, name, status, title, visits_count) and data found in a Widget table 4700. The data found in the Widget table 4700 may identify one or more data collection widgets (e.g., data collection interfaces) to be displayed as part of a data collection module, in addition to each data collection widget's display order position with respect to other data collection widgets.

In other embodiments, the information to be displayed in a data collection module is obtained by identifying what information should be collected from a visitor. For instance, step 5510 makes a request to the server 5015, requesting what information can or should be collected from a visitor. The server 5015 may respond with information about a specific data collection module associated to the element and its HTML selector. If a client wishes to record “up/down voting” data about a feature from a visitor, then step 5510 makes a request to the server 5015 and receives a response identifying that “up/down voting” data should be recorded. As a result, step 5510 identifies that an “up/down voting” widget should be displayed in step 5550. In some implementations, step 5510 may identify what information to be collected from a visitor without making a server request (e.g., such information is hardcoded). Step 5510 also assembles and displays a data collection module. In the present embodiment, step 5510 may be accomplished by opening a modal window on a visitor's browser, such as by using JavaScript. Furthering this example, after opening a modal window, step 5510 may assemble and display content for the modal window specific to a particular feature and a given visitor based, in whole or in part, on the information received from the server 5015 in step 5510. For instance, FIGS. 2a and 2b illustrate two modal windows with differing content based on information assembled for differing features and visitors. In some embodiments, the data collection module is displayed as a popover with content based on information assembled for a particular visitor. In certain embodiments, step 5510 may request a fully or partially assembled data collection module as an iframe from the server 5015. In some implementations, such as a native mobile application, step 5510 may assemble and display a data collection module on a screen within the native application or within a mobile web browser. In some embodiments, such as native desktop or backend applications (e.g., APIs), step 5510 may be accomplished without displaying a data collection module (e.g., recording user interaction without displaying a data collection module, such as by recording a trackpad gesture or eye-tracking from a webcam).

Step 5520 may track a visitor's interaction with a data collection module. In the illustrated embodiment, step 5520 includes an event handler for an interaction with a given feature. For example, an event handler may listen for a visitor click on a button of a data collection widget for a given feature. If such an event occurs, then step 5520 makes a request to server 5015, communicating that an interaction (e.g., a click) occurred for a given feature (identified by feature_id in a Feature table 4300) with a given visitor_id (identified by visitor_id in a Visitor table 4200). In response, the server 5015 may create a new database record in the Interaction table 4400. Step 5520 may also increment a cached counter in the Features table 4300 (e.g., the clicks_count field).

Step 5530 may include adding a tracked feature from step 5520 to a list. In the illustrated embodiment, the feature tracked in step 5520 is added to a list or index in a storage device 5540, such as a visitor web browser's local storage. In other embodiments, the feature tracked in step 5520 may be stored in a database. It may be desirable to include step 5530 to increment a counter that represents how many times a given data collection module was viewable to a visitor.

Step 5540 iteratively loops through the array of information about one or more data collection widgets identified in step 5510. For each data collection widget, step 5550 displays a data collection widget and listens for an event or data using one or more event handlers. For instance, if the data collection widget presents an up/down voting interaction, then the event handler listens for a visitor's click on the up-vote and down-vote buttons. If the visitor interacts with such buttons, then the event handler triggers step 5560.

Step 5560 makes a request to server 5015, communicating that an interaction (e.g., an upvote, a text response, an email address, or the like) occurred for a given data collection widget (identified by widget_id in a Widget table 4700), with a given visitor_id (identified by visitor_id in a Visitor table 4200). In response, the server 5015 may create a new database record in the Response table 4800. Continuing the previous example, if the data collection widget presents an up/down voting interaction, and a visitor clicked on the up-vote buttons, then step 5560 communicates the interaction “up” to server 5015, which creates a record in a database Response table 4800.

Step 5570 determines whether there are more data collection widgets to process in loop 5540. If not, then the process ends. If there are more data collection widgets to loop through in 5540, then the process proceeds to the next data collection widget at step 5550.

It is understood that the illustrated embodiment presents a “wizard style” data collection module that displays one data collection widget at a time and loops through an array of data collection widgets to display others if any. However, in other embodiments, a data collection module may display a plurality of data collection widgets and gather information from a visitor for each one without an iterative loop. Such an embodiment is accomplished by simultaneously displaying multiple data collection widgets and using one or more event handlers for each data collection widget.

### Alternative Embodiments

Many other embodiments are possible. In some embodiments various system elements or steps may be omitted or rearranged.

In one embodiment, similar to FIG. 1 c, a user 1010 interacts with a native mobile application on a mobile device (e.g., an iPhone) 1020. The mobile application 1020 includes API calls, where such API calls may incorporate functions sourced from a data management unit 1040, which may communicate with a server. The mobile application 1020 may execute one or more functions that communicate the mobile application's identity (e.g., by filename parameters or other hash values) and one or more user interactions (e.g., which application buttons were tapped or what user gestures were detected).

In this embodiment, the mobile application includes certain elements, such as a button identified by tag “100”. A function of the mobile application 1020 is configured so that a user 1010 tapping on the button with tag “100” communicates certain information to a data management unit (“DMU”) 1040, and, in response, a DMU 1040 responds with data to display a specific data collection module; whereas if the user 1010 swipes left on the button with tag “100”, the DMU 1040 responds with data to display a different data collection module.

Continuing this example, the user 1010 may tap, swipe, do both, or do neither of the gestures on the button with tag “100”, and such information is communicated to the DMU 1040, where the information may be stored in a storage device, such as a database. Additionally, if a user 1010 interacts with a data collection module (e.g., by tapping, swiping, inputting data), such interactions are communicated to the DMU 1040, where that information may be stored in a database.

In another embodiment, similar to FIG. 1 c, a user 1010 interacts with a personal computer native application that has access to the Internet 1020 (e.g., a “desktop application”). The desktop application 1020 includes an SDK library, where such SDK may incorporate functions sourced from a data management unit 1040, which may communicate with a server. The desktop application 1020 may execute one or more functions that communicate the desktop application's identity (e.g., by filename parameters or other hash values) and one or more user interactions (e.g., which application buttons were clicked or user interaction were detected).

In this embodiment, the desktop application includes certain elements, such as two buttons identified by Object ID “1” and Object ID “2”. A function of the mobile application 1020 is configured so that a user 1010 clicking on the button with Object ID “1” communicates certain information to a data management unit (“DMU”) 1040, and, in response, a DMU 1040 responds with data to display a specific data collection module; whereas if the user 1010 clicks on the button with Object ID “2”, the DMU 1040 responds with data to display a different data collection module.

Continuing this example, the user 1010 may click on button “1”, button “2”, both, or neither, and such information is communicated to the DMU 1040, where the information may be stored in a database. Additionally, if a user 1010 interacts with a data collection module (e.g., by clicking or mouseover), such interactions are communicated to the DMU 1040, where that information may be stored in a database.

In still another embodiment, similar to FIG. 1 c, a user 1010 interacts with an Internet accessible application programming interface (“API”) on a server 1020. The API 1020 may include an SDK library, where such SDK may incorporate functions sourced from a data management unit 1040, which may communicate with another server. The API 1020 may execute one or more functions that communicate the API's identity (e.g., by key-value pairs or other hash values) and one or more user interactions (e.g., which API endpoints were called).

In this embodiment, the API includes certain endpoints, such as two methods identified by method URL “/api/customer” and “/api/delete-all”. A function of the API 1020 is configured so that a user 1010 calling the API endpoint with URL “/api/customer” communicates certain information to a data management unit (“DMU”) 1040, and, in response, a DMU 1040 responds with data to display a specific data collection module (e.g., in JSONP or by providing a URL to a webpage that displays a data collection module like the one in FIG. 2a); whereas if the user 1010 calls the API endpoint with URL “/api/delete-all”, the DMU 1040 responds with data to display a different data collection module.

Continuing this example, the user 1010 may call endpoint URLs “/api/customer”, “/api/delete-all”, both, or neither, and such information is communicated to the DMU 1040, where the information may be stored in a database. Additionally, if a user 1010 interacts with a data collection module (e.g., by calling an API method to post a user interaction or by interacting with a data collection module at a URL), such interactions are communicated to the DMU 1040, where that information may be stored in a database.

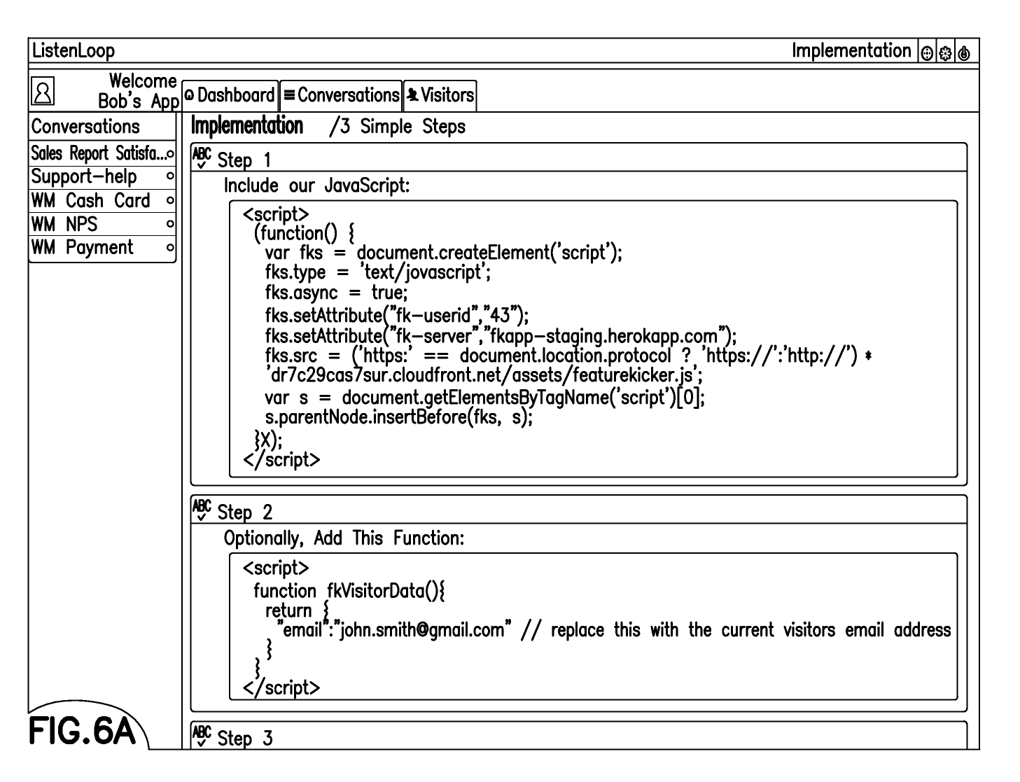

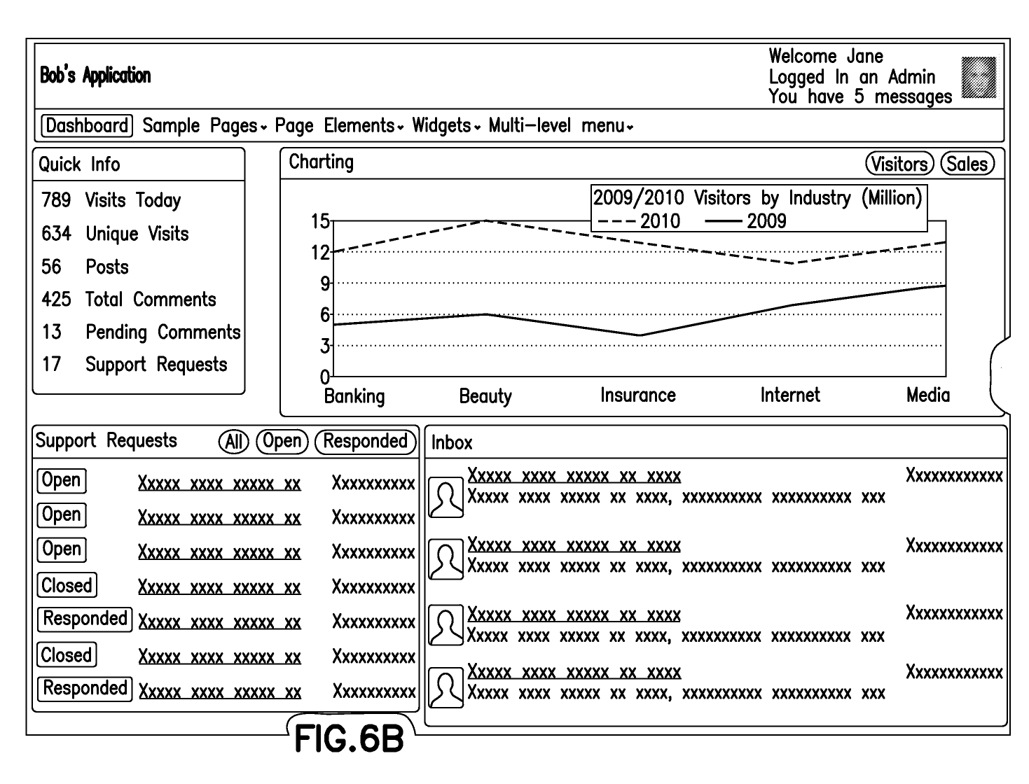

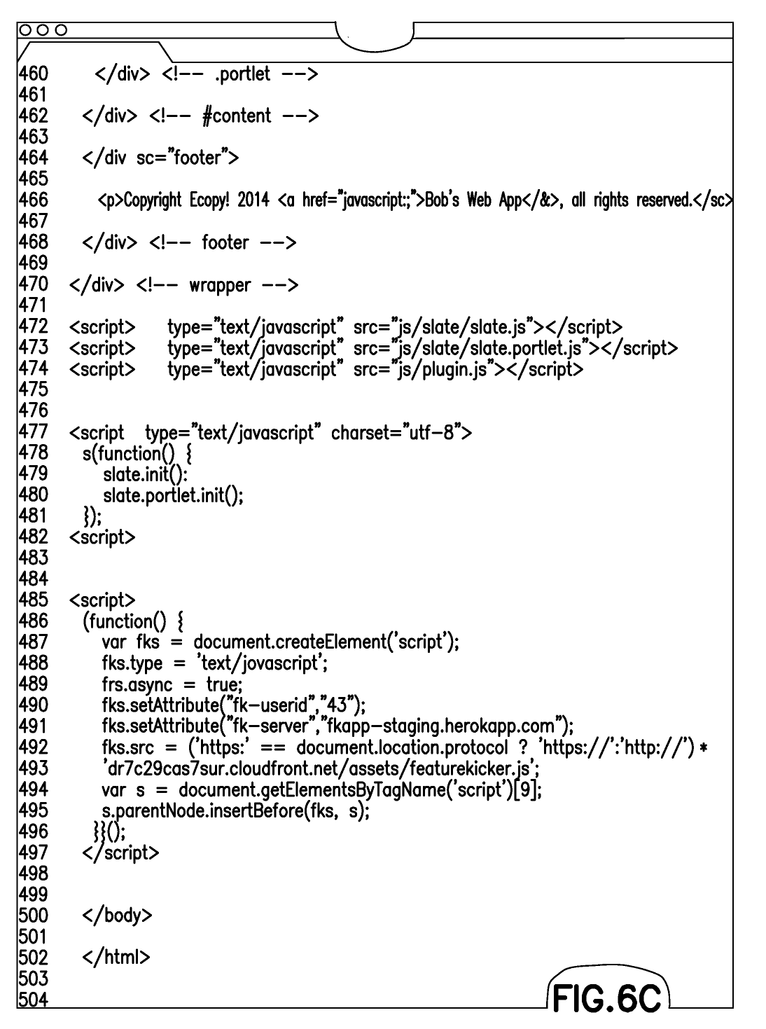

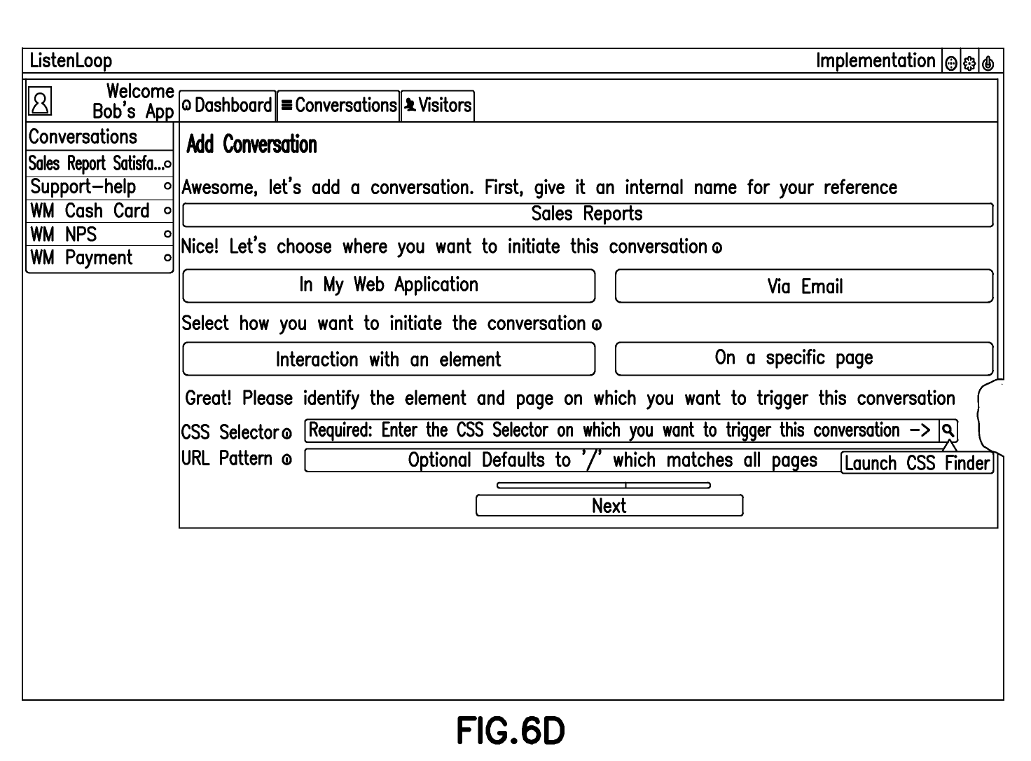

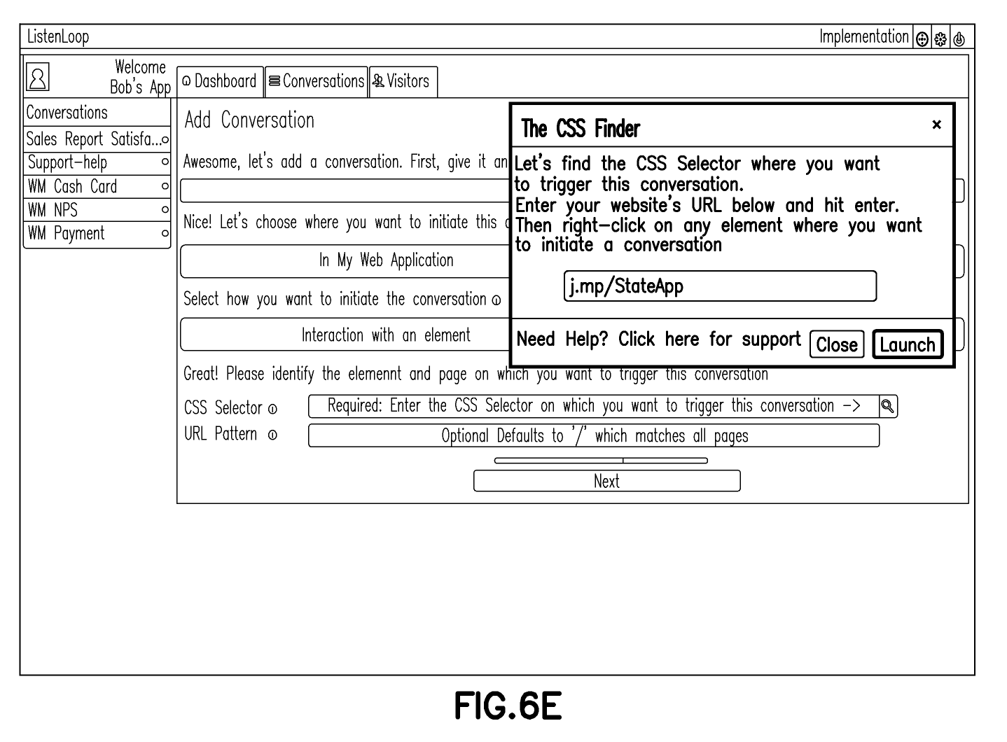

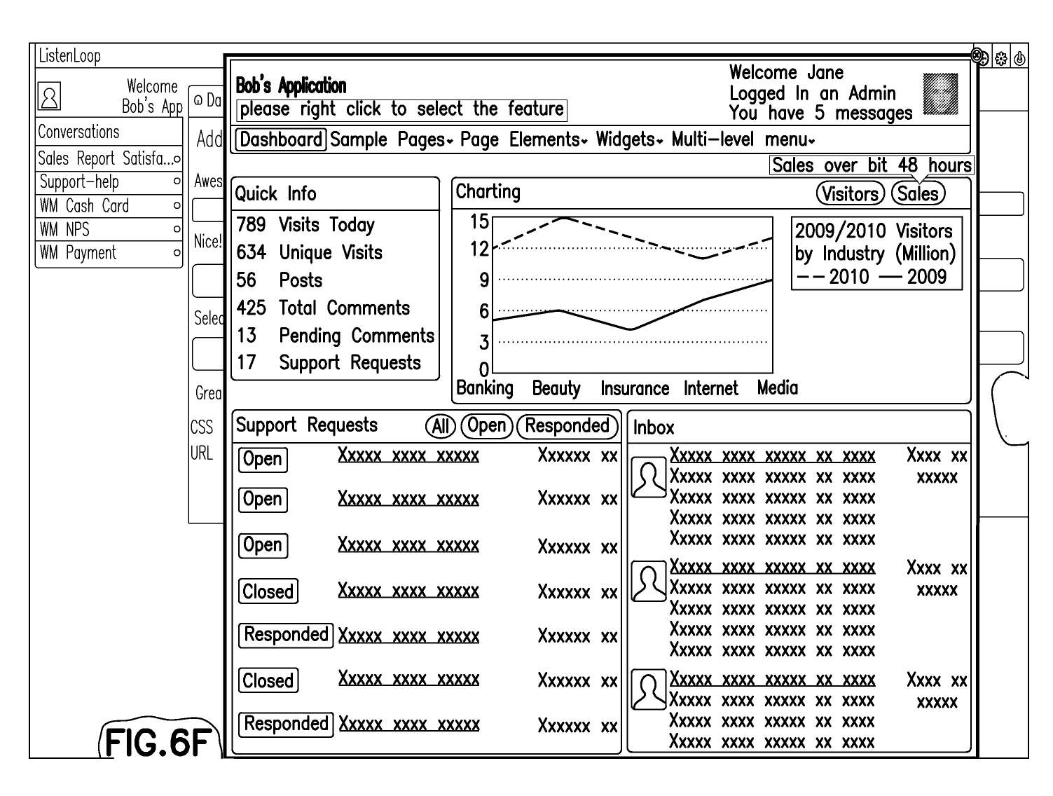

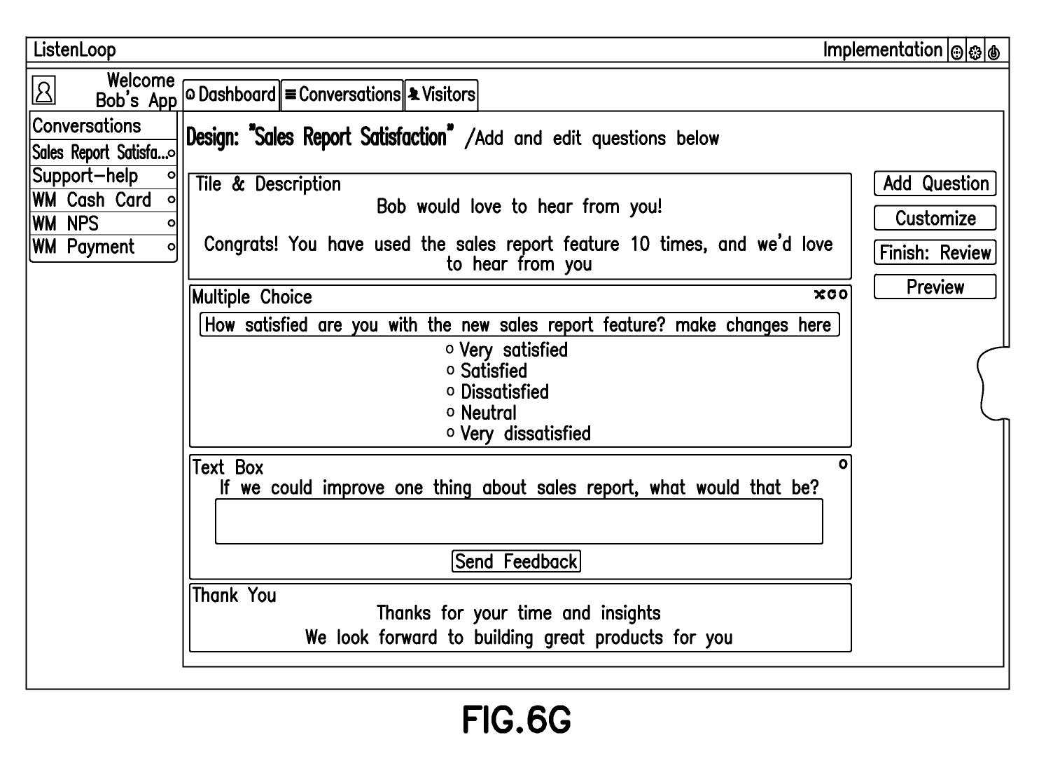

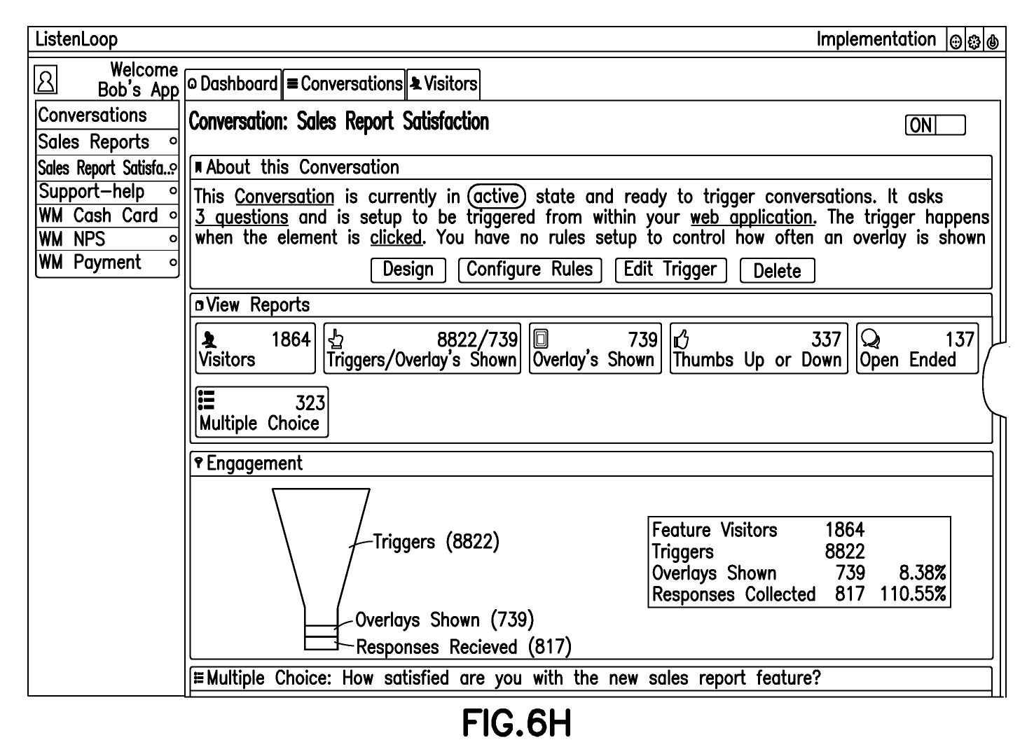

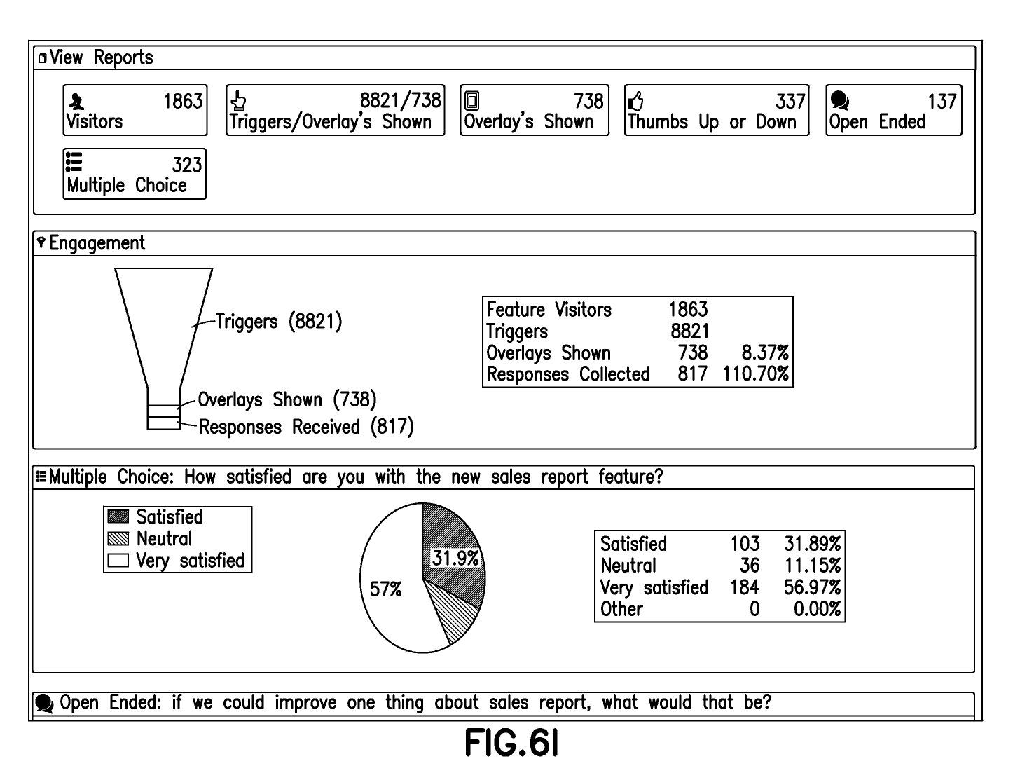

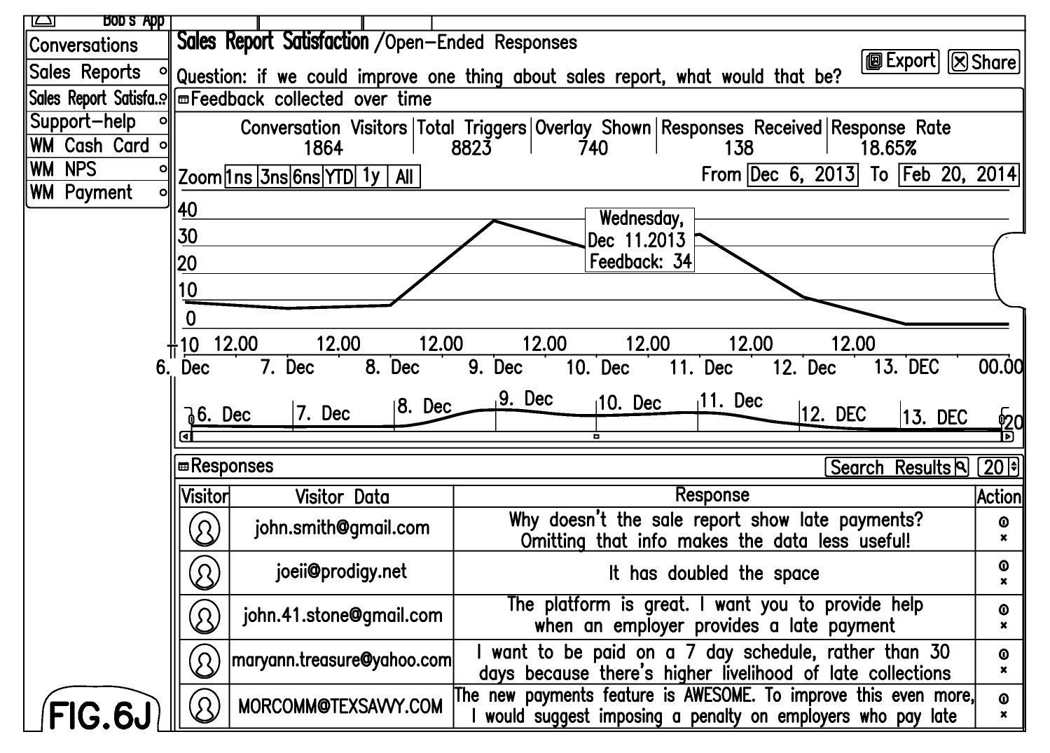

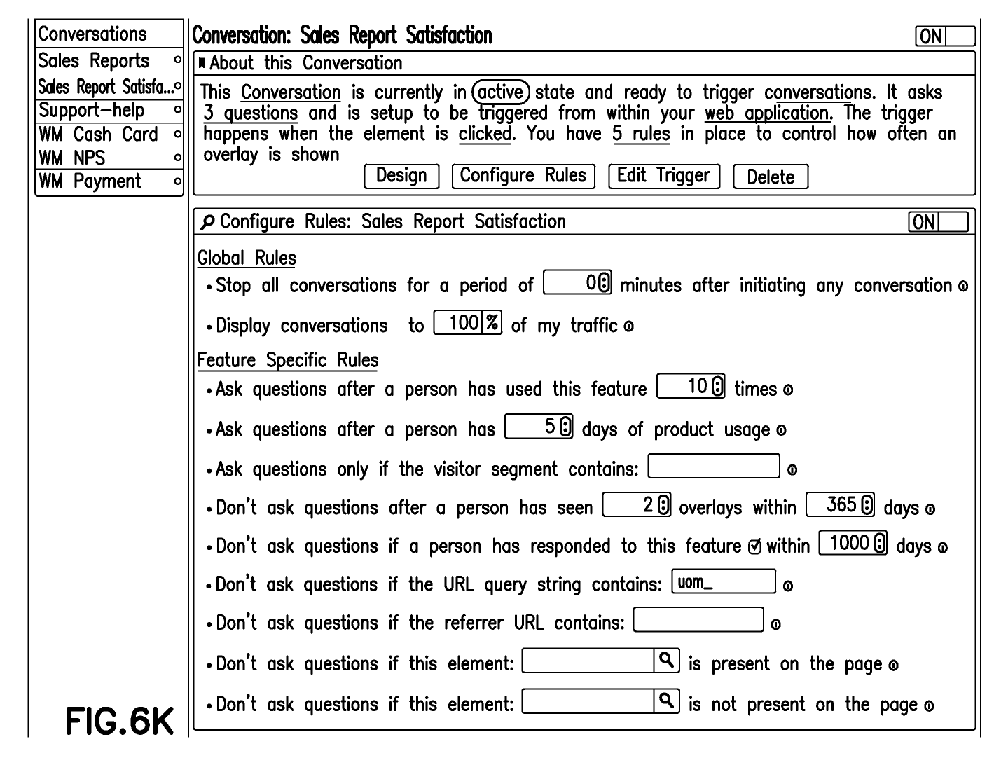

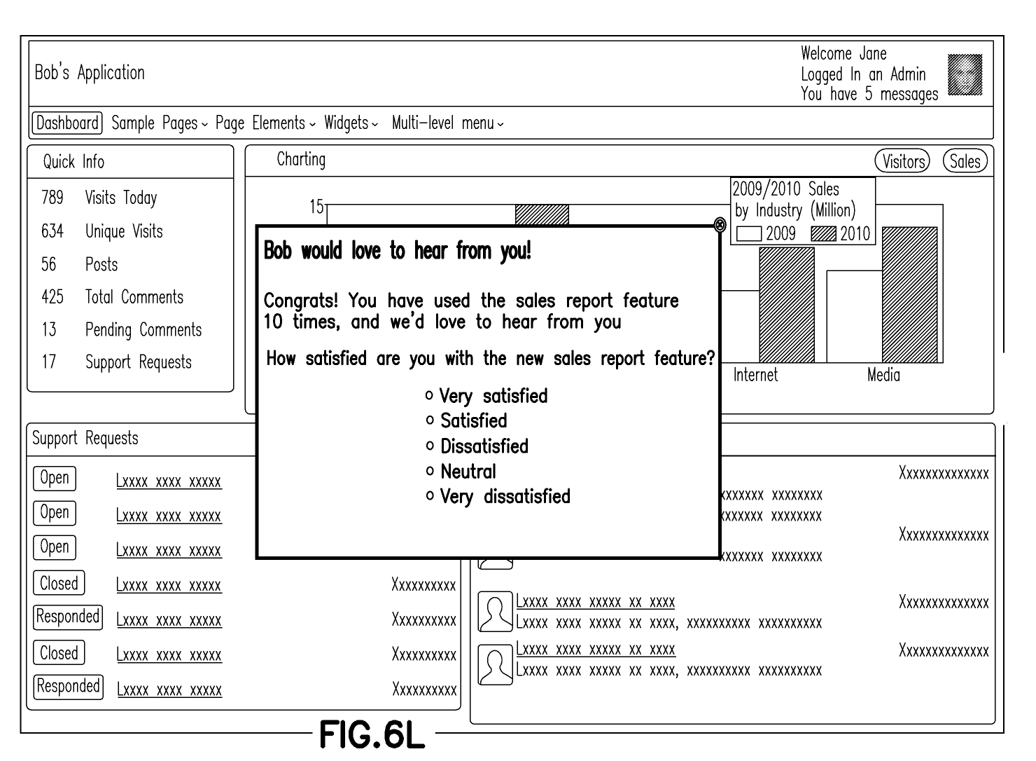

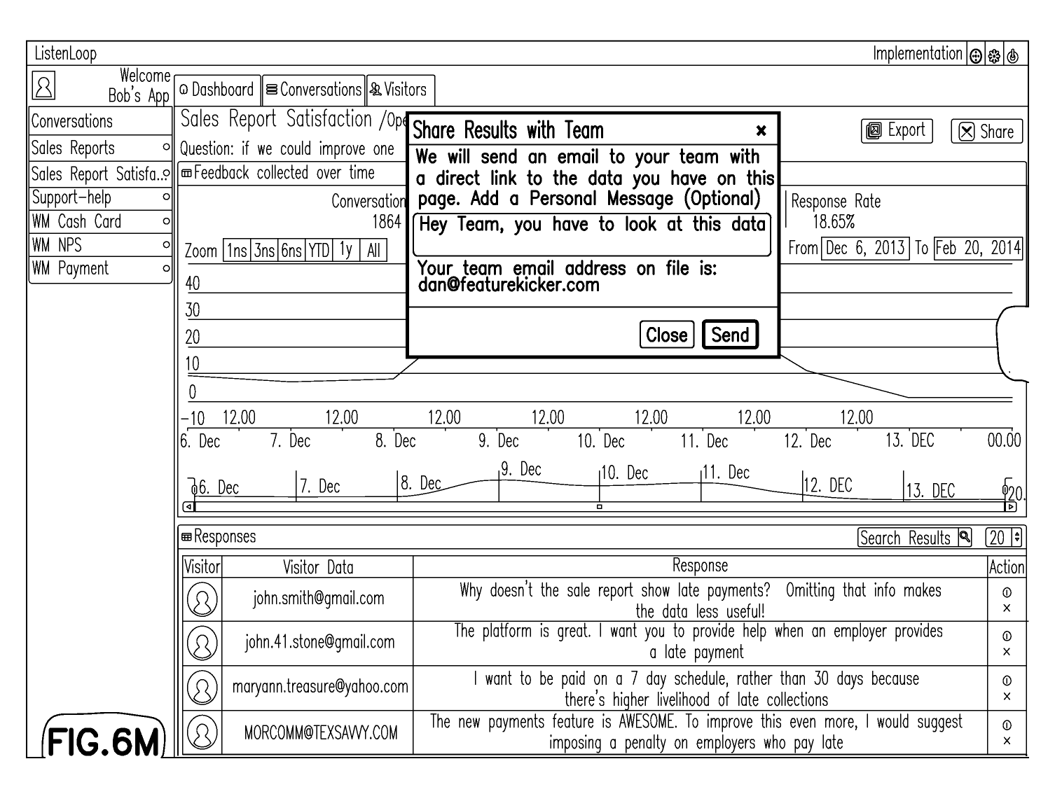

FIGS. 6A to 6M show an exemplary sequence of screenshots that would be viewable at a computer-based user interface (e.g., a desktop computer or the like) by a website administrator (FIGS. 6A to 6J and 6M) or by a person visiting the administered website (FIGS. 6K and 6L), according to one implementation of the concepts disclosed herein. More particularly, FIGS. 6A to 6J show an exemplary sequence of screenshots and steps that the website administrator would navigate in setting up his or her website, which is labeled “Bob's Application” in the figures provided, to accommodate one or more of the functionalities described herein. Moreover, FIGS. 6K and 6L show an exemplary sequence of screenshots that a visitor to the “Bob's Application” website might see when he or she performs certain actions at the website. Finally, FIG. 6M shows an exemplary sequence of screenshots that the website administrator might see after the visitor's interactions with the website.

FIG. 6A shows a screenshot of a website that the administrator might access to obtain sections of computer code (e.g., JavaScript tags) that the website administrator can simply copy and paste into the HTML code for his or her “Bob's Application” website to give that website one or more of the functionalities disclosed herein.

In the illustrated example, the upper section of the illustrated screenshot (labeled, “Include our JavaScript”) includes a section of computer code that, if pasted into the HTML code for the “Bob's Application” website, would enable the website administrator to intuitively and easily to design into the website (and modify as desired) “in-application” questions for visitors to the website that are triggered by certain types of visitor activities that are specified by the website administrator during the design process. The answers to these questions can be viewed and analyzed by the website administrator and his or her team to gain a deep understanding of visitors to the website, their likes and dislikes and various other information.

In the illustrated example, the lower section of the illustrated screenshot (labeled, “Optionally, Add This Function”) includes a section of computer code that, if pasted into the HTML code for the “Bob's Application” website, would enable the website administrator to know which visitors to the website have provided responses to any of the “in application” questions that the website administrator designed into the website.

In a typical implementation, the website administrator would copy and paste one or both sections of computer code shown in the illustrated screenshot into the HTML code for his “Bob's application” website. The sections of computer code shown in FIG. 6A can be provided to the website administrator in a number of possible ways. For example, in some implementations, the sections of code are made available from a website. In those implementations, the sections of code can be copied directly from the website or in a file that is downloaded from the website. In some implementations, the sections of code can be emailed or texted to the website administrator. The sections of computer code can be provided to the website administrator in a number of other possible ways as well.

In a typical implementation, the website administrator would simply copy the section of computer code from the “Include our JavaScript” section of the screenshot in FIG. 6A and paste it into the HTML code for the “Bob's Application” website. Likewise, the website administrator, if he or she desired the additional functionality associated with the additional section of code, would simply copy and paste the section of computer code from the “Optionally, Add This Function” section of the screenshot in FIG. 6A into the HTML code for the “Bob's Application” website.

FIG. 6B shows an example of the “Bob's application” website. FIG. 6C shows a section of the HTML code for the “Bob's Application” website. In a typical implementation, the section(s) of code copied from the screenshot of FIG. 6A would be pasted immediately above the closing body tag in the HTML code for the “Bob's Application” website.

In a typical implementation, these relatively simple steps would give the website administrator (or others that have permission to do so) the ability to intuitively and easily design into the “Bob's Application” website (and modify as desired) “in-application” questions for and conversations with visitors to the website that are triggered by certain types of visitor activities specified by the website administrator during the design process. Thus, it can be seen that, according to the techniques disclosed herein, providing these powerful functionalities into a website is very easy.

Assume, for purposes of one example, that Bob has recently incorporated a sale's reporting feature into the “Bob's Application” website (an example of this sale's reporting feature is shown, in part, in FIG. 6B) and Bob wants to get feedback from visitors to the website about whether the visitors like the new sale's reporting feature or not. FIG. 6D shows a screenshot that the website administrator can access that lets him or her add a conversation (e.g., with one or more in-application questions) into the “Bob's Application” website about the new sale's reporting feature. This conversation, which can be triggered by events that the website administrator designates, can solicit feedback from directly from visitors themselves about the new sale's reporting while the visitor is at the website and viewing or interacting with the new sale's reporting feature.

According to the example shown in FIG. 6D, the “Add Conversation” screenshot presents a number of prompts or questions to the website administrator to help the website administrator design the conversation. For example, first the screenshot asks the website administrator to give the conversation an internal name. In this example, the website administrator gives the conversation the name “Sales Reports” to reflect that the conversation will relate to the new sales reporting feature on the “Bob's Application” website.

The screenshot asks the website administrator to choose where he or she wants to initiate this conversation. The choices provided to the website in the illustrated example include, “In My Web Application” or “Via Email.” If the website administrator chooses the “In My Web Application” option, then any questions or interactions with a visitor to the “Bob's Application” website that happen pursuant to this particular conversation will happen on the “Bob's Application” website. If the website administrator chooses the “Via Email” option, then any questions or interactions with a visitor to the “Bob's Application” website that happen pursuant to this particular conversation will happen via an email communication with the visitor. In various implementations, other or different choices (e.g., via text or other means) may be presented to the website administrator as well.

The screenshot also asks the website administrator to choose how he or she wants to initiate the conversation. The choices provided to the website administrator in the illustrated example include, “Interaction with an element” or “On a specific page.” If the website administrator chooses the “Interaction with an element” option, then the conversation will be initiated in response to a visitor to the “Bob's Application” website interacting with (e.g., selecting, hovering over, etc.) a certain element (e.g., a hyperlink button or other visual component at the “Bob's Application” website. If the website administrator chooses the “On a specific page” option, then the conversation will be initiated in a response to a visitor to the “Bob's Application” website navigating to a specific page (e.g., the page that includes some part of the new sales reporting feature) on the “Bob's Application” website. In various implementations, the screenshot can present other or different options to initiate a conversation.

For purposes of one example, let's assume that the website administrator has chosen to initiate the Sales Report conversation “In My Web Application” and has chosen that the initiating should occur in response to “Interaction with an element.” The screenshot asks the website administrator to identify the URL of the webpage where the conversation should occur and the specific element and page on which he or she wants to trigger this conversation.

Elements on a website can be represented by Cascading Style Sheets (CSS). In general, CSS is a style sheet language used for describing the look and formatting of a document written in a markup language HTML). In the illustrated example, the website administrator can specify what specific element should trigger the conversation by specifying the CSS for that element. Moreover, the screenshot includes a button to launch a “CSS Finder,” which is a tool that makes finding and specifying the CSS for a particular element very easy and intuitive.

Selecting the “CSS Finder” button enables the website administrator to access “CSS Finder” functionality. In atypical implementation, the CSS Finder functionality provides an easy and intuitive way for the website administrator to specify CSS associated with the website element that will be designated to initiate the conversation.

FIG. 6E shows an example of how the CSS Finder functionality can be accessed. According to the illustrated example, selecting the “CSS Finder” button causes a popup box (“The CSS Finder”) to appear. The CSS Finder prompts the website administrator: 1) to enter the website's URL (which, in this example, would be for the “Bob's Application” website) and hit enter, and 2) then right-click on any element where he or she wants to initiate the conversation.

Entering the URL for the “Bob's Application” website and hitting enter causes a version of the “Bob's Application” website appears on the screen, as shown in FIG. 6F. To specify which element on that page should trigger the conversation, the website administrator can simply maneuver his or her mouse around that version of the “Bob's Application” website and “right click” on whichever element he or she wants to use for triggering or initiating the conversation. Of course, other methods besides right clicking can be used to select an element in this regard.

In a typical implementation, this simple, intuitive process provides the system with the CSS it needs in order to relate the conversation being created to the particular element on the webpage, the interaction with which will trigger the conversation.

In the screenshot in FIG. 6G, the system enables the website administrator to design certain aspects of the conversation with visitors to the website. More particularly, the exemplary screenshot includes a series of prompts or questions to solicit information from the website administrator about what the website administrator wants the conversation to include.

In the illustrated example, one of the prompts or questions asks the website administrator to provide a title & description for the conversation. In a typical implementation, the title & description provided represents a greeting that will be presented to a website visitor when the conversation is initiated with that website visitor. In the illustrated example, the website administrator enters, “Bob would love to hear from you!” as the title and “Congrats! You have used the sales report feature 10 times and we'd love to hear from you.” as the description.

The illustrated screenshot includes an “Add Question” button, the selection of which gives the website administrator the option to add questions into the conversation. In a typical implementation, this Add Question functionality enables the website administrator to add as many questions and as many different types of questions (e.g., multiple choice, true/false, open ended, thumbs up/thumbs down, rating on a scale of 1-10, etc.) as desired.

In the illustrated example, the website administrator, by accessing the Add Question functionality, is adding one multiple choice question and one open ended question to follow the multiple choice question. The multiple choice question will ask visitors to the “Bob's Application” website the following question, which would have been written into the illustrated text box by the website administrator: “How satisfied are you with the new sales report feature?” The multiple choices, which also may have been written by the website administrator (or, optionally, presented as boilerplate choices by the system), include: “Very satisfied,” “satisfied,” dissatisfied,” neutral,” and “very dissatisfied.”

In the illustrated example, the website administrator, by accessing the Add Question functionality, also is adding the following open-ended question, which will follow the multiple choice question in the conversation with the visitor: “if we could improve one thing about the sales report, what would that be?” The open-ended question will include a text box for the website visitor to provide his or her feedback to the open-ended question and a button, labeled “Send Feedback” to send any feedback provided through the system to the website administrator.

The system also enables the website administrator to design a valediction for the conversation, which, in the illustrated example, reads, “Thanks for your time and insights. We look forward to building great products for you.”

Anytime the website administrator wants to preview how the conversation he or she is designing will appear to a visitor to the “Bob's Application” website, the website administrator can click on the “Preview” button, which will show a version of the “Bob's Application” website that includes any conversation-functionality that has been designed using the tools available at the screen shown on FIG. 6G.

When the website administrator believes that the conversation design is complete, he or she can click on the “Finish/Review” button. This causes the system to show to the system administrator a version of the “Bob's Application” website that includes any conversation-functionality that has been designed into the website using the tools available at the screen shown on FIG. 6G. If the website administrator is satisfied with and wants to make the conversation available to actual visitors at the “Bob's Application” website, atypical implementation includes a virtual toggle switch to make the conversation available and/or make the conversation unavailable. An example of this virtual toggle switch is shown near the upper right hand corner of the screenshot in FIG. 6H, in the “ON” or activated state. Once designed, therefore, it is very easy to activate or deactivate a conversation on a website.

FIG. 6H is an exemplary screenshot showing a collection of reports about an active “Sales Report Satisfaction” conversation at the “Bob's Application” website. This is a screenshot that would generally be accessible by the website administrator who designed the “Sales Report Satisfaction”.

First, the illustrated screenshot has a section that includes a short description of the conversation. This section is entitled “About this Conversation” and says, “This conversation is currently in active state and ready to trigger conversations. It asks 3 questions and is setup to be triggered from within your application. The trigger happens when the element is clicked. You have no rules setup to control how often an overlay is shown.”

The screenshot also includes a number of selectable buttons labeled, “Design,” Configure Rules,” “Edit Trigger,” and “Delete.” In a typical implementation, selecting the “Design” button enables the website administrator to edit the design (e.g., the number of questions, types of questions, language of the questions, messages, etc.) of the corresponding conversation (e.g., the “Sales Report Satisfaction” conversation). In a typical implementation, selecting the “Configure Rules” button enables the website administrator to set up rules associated with the conversation including, for example, how often and/or to whom the conversation should be presented. In a typical implementation, selecting the “Edit Trigger” button enables the website administrator to edit what will trigger (e.g., to specify a different CSS element) the conversation. In atypical implementation, selecting the “delete” button will delete the conversation.

Beneath these buttons, there is a section entitled “view reports.” In that section, there are links to several different types of reports about the conversation. In the illustrated screenshot, for example, there are links to a “visitors” report, a “triggers/overlays shown” report, an “overlays shown” report, a “thumbs up or down” report, an “open ended” report and a “multiple choice” report. In atypical implementation, the “visitors” report would include information about the specific visitors to the website (e.g., who they are, how often each has visited, etc.). In a typical implementation, the “triggers/overlays shown” report includes information relating to how many triggers have occurred per overlay shown for the particular conversation. In a typical implementation, the “overlays shown” report includes information on the total number of overlays shown. In a typical implementation, the “thumbs up or down” report includes information about how much feedback received on the new sales reporting feature has been positive and how much has been negative. In a typical implementation, the “open ended” report and the “multiple choice” report include information about specific responses received from the visitors to open ended questions and multiple choice questions in the conversation, respectively. Each link under the “View Reports” header includes a number that, in a typical implementation, would show how many pieces of relevant data are included in the corresponding report that relate to the indicated topic.

Beneath the “view reports” section is a section entitled, “Engagement” that includes information reflecting how visitors to the website, or more particularly to the new sales reporting feature on the website, are engaging with the conversation. In particular, the illustrated engagement information includes the total number of feature visitors, the total number of triggers that have occurred, the total number of overlays shown and the total number of responses collected. This information is provided in the illustrated example numerically as well as graphically. In atypical implementation, this sort information can help website administrators understand how to improve visitor engagement with a conversation. More particularly, the website administrator can compare the designs of highly engaged conversations with conversations that are not as highly engaged and try to make adjustments to the less engaged conversations accordingly.

FIG. 6I shows the same page as FIG. 6H, but scrolled down a bit to reveal a section entitled, “Multiple Choice: How satisfied are you with the new sales report feature?” This section includes a numerical summary and a graphical summary of feedback received from visitors to the website about the indicated multiple choice questions.

FIG. 6J shows an example of a webpage that can be accessed by the website administrator to see information about feedback regarding an open-ended question in a conversation (e.g., “If we could improve one thing about the sales report feature, what would that be?”).

The illustrated screenshot has an upper section with a graphical and numerical summary of feedback received over time, and a lower section with listing of specific comments received from the individual visitors. The listing of specific comments can be sorted based on keywords by using the “search results” box and its associated searching functionality shown in the illustrated screenshot in the header of the listing.

In a typical implementation, this page and/or other pages) may include other information about the conversation(s) and feedback received pursuant to the conversation(s). As shown, in a typical implementation, the information is organized in a simple, clear, useful manner.

FIG. 6K shows an example of a screenshot that the website administrator can access in order to configure rules about a particular conversation. The illustrated example is for a “Sales Report Satisfaction” conversation and includes a series or prompts or questions that the website administrator can respond to in order to configure the rules.

The prompts are grouped under two headings: those that relate to “Global Rules” and those that relate to “Feature Specific Rules.” In a typical implementation, the global rules apply across the entire website, whereas the feature specific rules apply to only one or more specific features (e.g., visual objects, links, etc.) on the website. The feature specific rules typically do not apply across an entire website.

The exemplary prompts that, in the illustrated screenshot, relate to global rules ask the website administrator: 1) to specify if (and for how many minutes) after initiating any conversation all other conversations should be stopped (e.g., prevented from happening); and 2) to specify what percentage of traffic (e.g., visitors) to the website should be presented with conversations. Other prompts relating to global rules may be provided as well.

The exemplary prompts that, in the illustrated screenshot, relate to feature specific rules ask the website administrator to specify conditions under which questions may be asked (i.e., conversations may be initiated) including: 1) only after a visitor visits the feature a certain number of times; 2) only after a visitor has used a product (i.e., feature) a certain length of time; 3) only if the visitor segment contains certain information; 4) not if the visitor has seen a certain number of overlays in a certain period of time; 5) not if the visitor has responded (i.e., to the conversation about this feature) within a certain period of time; 6) not if the URL query string contains certain information; 7) not if the referrer URL includes certain information; 8) not if a certain element is present on the page; and 9) unless a certain element is present on the page. Other prompts relating to feature specific rules may be provided as well.

After a conversation is setup, anytime a triggering event occurs and the requisite rules provide for a conversation to be initiated, a conversation will be initiated. FIG. 6L shows an example of what might appear when a conversation is initiated (e.g., by a visitor triggering the conversation) at the “Bob's Application” website. As shown, a popup box appears that includes a greeting and initial question that have been programmed in (e.g., by a website administrator). Once that question is answered, other questions may follow, or the conversation may end (e.g., by the system presenting a valediction to the visitor).

In some implementations, a conversation may be an ongoing, active one, giving the website administrator an opportunity to respond, in the application, to any or all feedback received. In those instances, a dialog box may stay open and visible to a visitor (with a response to feedback previously received from that visitor). In those instances, until the dialog box is closed, the dialog box may remain open and available at the webpage every time the particular visitor visits the website. This may facilitate an ongoing exchange between the visitor and a website administrator about some conversation topic (e.g., the favorability of a newly-added or contemplated feature into the website).

FIG. 6M shows a screenshot that enables the website administrator to easily share feedback from the system with other members of the website administrator's team.

In a typical implementation, the website functionalities described herein are enabled by adding one or more sections of JavaScript to the website's HTML and the website subsequently interacting with a server that includes one or more computer-based processors and one or more memory devices that facilitate the website functionalities described herein.

### CONCLUSION

A number of embodiments of the invention have been described. Nevertheless, it will be understood that various modifications may be made without departing from the spirit and scope of the invention.

For example, embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

Computer storage mediums can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing.

Computer programs (also known as programs, software, software applications, scripts, or codes) can be written in any form of programming language, including compiled or interpreted languages, declarative or procedural languages, and can be deployed in any form.

The processes and logic flows described in this specification can be performed by one or more programmable processors executing one or more computer programs to perform actions by operating on input data and generating output.

Processors suitable for the execution of a computer program include, by way of example, both general and special purpose microprocessors, and any one or more processors of any kind of digital computer. Generally, a processor will receive instructions and data from a read-only memory or a random access memory or both.

A computer device adapted to implement or perform one or more of the functionalities described herein can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including, for example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented using a computer device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Other implementations are within the scope of the claims.

What is claimed is:

1. A computer-implemented method comprising:
displaying an element at a web-based information resource rendered on a computer-based user interface device,
enabling a user to interact with the element from the computer-based user interface device, and
in response to the user interacting with the element at the computer-based user interfaced device, displaying a data collection module at the computer-based user interface device,
wherein the data collection module is configured to solicit data from the user about the element, the user or the user's opinion about the element.

2. The computer-implemented method of claim 1, wherein the element has an appearance that suggests a functionality not available to the user by interacting with element.

3. The computer-implemented method of claim 1, further comprising:
generating one or more reports based, at least in part, on data gathered through the data collection module from the user at the computer-based user interface device and from other users at the computer-based user interface device or at other computer-based user interface devices.

4. The computer-implemented method of claim 1, wherein the data collection module has a visual style that resembles a style of the web-based information resource.

5. The computer-implemented method of claim 1, wherein the data collection module is selectively displayed based on one or more criteria having been satisfied.

6. The computer-implemented method of claim 5, wherein each of the one or more criteria is selected from the group consisting of: geo-location criteria, browser session length criteria, visit frequency criteria, time period criteria, and uniform resource locator (URL) parameter criteria.

7. The computer-implemented method of claim 1, further comprising:
uniquely identifying, using tokens, the user and one or more other users that access the web-based information resource.

8. The computer-implemented method of claim 1, wherein the data collection module is displayed at the computer-based user interface device without navigating away from the web-based information resource.

9. The computer-implemented method of claim 1, further comprising:
recording the user's interactions with the data collection module.

10. The computer-implemented method of claim 1, wherein the web-based information resource is software application,
and
wherein the data collection module transmits gathered data to a storage device.

11. The computer-implemented method of claim 1, further comprising:
receiving an indication that the user has interacted with the feature displayed at the web-based information resource on the computer-based user interface device; and
in response to the received indication, soliciting feedback from the user through the data collection module as to the user's interest in functionality that the element's appearance suggests but does not provide.

12. The computer-implemented method of claim 11, wherein the data collection module presents one or more of the following inquiries to the user:
whether the user thinks the associated functionality should be made available at the web-based information resource;
why the user thinks the associated functionality should be made available at the web-based information resource;
whether the user is interested in participating in a beta test for the associated functionality; and
whether the user is interested in pre-paying or willing to pre-pay for access to the associated functionality.

13. The computer-implemented method of claim 12, further comprising:
receiving a user response to the one or more inquiries from the computer-based user interface device;
receiving a plurality of other user responses to the one or more inquiries from other computer-based user interface devices; and
assessing whether to make the associated functionality available via the web-based information resource, based on the user-response and the other user responses.

14. The computer-implemented method of claim 1, wherein the web-based information resource is selected from the group consisting of: a website, a webpage, a mobile application, a native application, an application programming interface, a SMS text application, a chat application, an email application, and an image, video or other piece of content that has access to a network.

15. The computer-implemented method of claim 20, wherein the element's appearance suggests the associated functionality by including text or having a visual appearance that relates to the associated functionality.

16. The computer-implemented method of claim 1, wherein the element is displayed at the computer-based user interface device in association with the web-based information resource.

17. The computer-based method of claim 20, wherein the user interaction is selected from the group consisting of: clicking, double-clicking, highlighting, hovering-over, touching, swiping, pinching, a mouse out or otherwise interacting with the element, and shaking the computer-based user interface device.

18. The computer-implemented method of claim 1, wherein the data collected about the user via the data collection module relates to psychographic information.

19. The computer-implemented method of claim 1, wherein the element is associated with a feature that is available to the user.

20. A computer system, comprising:
a plurality of computer-based user interface devices; and
one or more computer-based processing units coupled to the plurality of computer-based user interface devices via a network, wherein the one or more computer-based processing units are configured to:
provide an element for display at a web-based information resource;
receive an indication that a user has interacted with the element at a particular one of the computer-based user interface devices; and
in response to the received indication, display a data collection module at the web-based information resource on the particular one of the computer-based user interface devices to solicit data from the user at the particular computer-based user interface device.

21. The computer system of claim 20, wherein the element has an appearance that suggests an associated functionality not available through the element on the web-based information resource.

22. The computer system of claim 20, wherein the web-based information resource is selected from the group consisting of: a website, a webpage, a mobile application, a native application, an application programming interface, a SMS text application, a chat application, an email application, and an image, video or other piece of content that is accessible from the computer-based user interface device via a network.

23. The computer system of claim 20, wherein the element is displayed at the particular computer-based user interface device in association with the web-based information resource.

24. The computer system of claim 20, wherein the user interaction is selected from the group consisting of: clicking, double-clicking, highlighting, hovering-over, a mouse out, and touching, swiping, pinching or otherwise interacting with the feature for display.

25. The computer system of claim 20, wherein the data collection module is selectively displayed based on satisfying one or more criteria,
wherein the one or more criteria is selected from the group consisting of: a geo-location criteria, a browser session length criteria, a visit frequency criteria, a time period criteria, and a uniform resource locator (URL) parameter criteria.

26. The computer system of claim 20, wherein the one or more computer-processing units are configured to uniquely identify, using tokens, the user and one or more other users that access the web-based information resource.

27. The computer system of claim 20, wherein the data collection module is displayed at the computer-based user interface device without navigating away from the web-based information resource.

28. A non-transitory, computer-readable medium that stores instructions executable by a processor to perform the steps comprising:
providing an element for display at a web-based information resource;
receiving an indication that a user has interacted with the element at a particular one of the computer-based user interface devices; and
in response to the received indication, display a data collection module at the web-based information resource on the particular one of the computer-based user interface devices to solicit data from the user at the particular computer-based user interface device.

29. A computer-based method comprising:
providing a segment of software code that can be copied and pasted into software code for a web-based information resource, wherein the segment of software code, when incorporated into the code for the software application enables:
the web-based information resource to open a data collection module when a user triggers opening the web-based information resource by interacting with an element that appears at the web-based information resource on a computer-based user interface device accessing the web-based information resource,
wherein the data collection module is configured to solicit data from the user about the element, the user or the user's opinion about the element.
